(19) United States
(12) Patent Application Publication
(10) Pub. No.: US 2026/0351954 A1
(43) Pub. Date: Nov. 5, 2026

(54) NOISE FILTER, POWER CONVERSION SYSTEM, AND MANAGEMENT SYSTEM

(71) Applicants: Mitsubishi Electric Corporation, Tokyo (JP); Mitsubishi Electric Engineering Company Limited, Tokyo (JP)

(72) Inventors: Yasuaki FURUSHO, Tokyo (JP); Yuki FUJITA, Tokyo (JP)

(73) Assignees: Mitsubishi Electric Corporation, Tokyo (JP); Mitsubishi Electric Engineering Company Limited, Tokyo (JP)

(21) Appl. No.: 19/116,401

(22) PCT Filed: Oct. 7, 2022
(86) PCT No.: PCT/JP2022/037561

§ 371 Date: Mar. 28, 2025

(51) Int. Cl. H02M 1/44; H02H 1/00; H02H 7/125; H02M 1/00; H02M 1/40

(52) U.S. Cl. CPC H02M 1/44; H02H 1/0007; H02H 7/125; H02M 1/0012; H02M 1/0038; H02M 1/40

(57) ABSTRACT

A noise filter of the present disclosure is provided on an electric path connecting an AC or DC power supply and a power conversion device which converts power outputted from the power supply to AC or DC power, or an electric path connecting the power conversion device and a load, the noise filter including: a noise detection unit which detects common mode noise occurring during operation of the power conversion device; a cancellation signal generation unit which generates a cancellation signal for canceling out the common mode noise; a cancellation signal injection unit which injects the cancellation signal into the electric path; and an abnormality detection unit which outputs an abnormality detection signal upon detection of an abnormal cancellation signal. An abnormality processing sequence is executed on the basis of the abnormality detection signal.

### TECHNICAL FIELD

The present disclosure relates to a noise filter, a power conversion system, and a management system.

### BACKGROUND ART

There is known a power conversion device that converts input power from a power supply to desired DC power or AC power and supplies the converted power to a load. The power conversion device performs power conversion by opening and closing a plurality of switching elements connected in a bridge form, and high-frequency noise occurs due to operations of the switching elements. The high-frequency noise becomes a cause for common mode noise which flows through a parasitic capacitance or the like and then a ground potential to a power supply or a load. In order to suppress such common mode noise, there is known a configuration in which a noise filter is provided to an electric path between the power supply and the power conversion device or an electric path between the power conversion device and the load.

One of noise filters is an active noise filter. For example, an active noise filter described in Patent Document 1 detects common mode voltage via a ground capacitor connected to an electric path between an AC power supply and a rectifier, generates cancellation voltage having the same magnitude as and a polarity opposite to the detected common mode voltage by a cancellation voltage source, and superimposes the cancellation voltage between the AC power supply and a connection point of the ground capacitor on the electric path. Thus, the active noise filter described in Patent Document 1 injects the cancellation voltage for canceling out the common mode voltage which is common mode noise, as a noise cancellation signal (hereinafter, referred to as cancellation signal), into the electric path.

### CITATION LIST

### Patent Document

Patent Document 1: Japanese Laid-Open Patent Publication No. 2010-57268

### SUMMARY OF THE INVENTION

### Problem to be Solved by the Invention

During operation of the active noise filter, the control characteristic of the active noise filter can change due to an environmental factor, a temporal factor, or the like. In the active noise filter described in Patent Document 1, in a case where the control characteristic undergoes such change that was not assumed at the time of designing, loss of a control margin (gain margin and phase margin) or the like occurs, so that the cancellation signal to be injected into the electric path oscillates or a compensation amount in noise cancellation becomes excessive, and thus an abnormal cancellation signal is generated.

When the abnormal cancellation signal is injected into the electric path, the common mode noise cannot be canceled out and in addition, the cancellation signal might cause a problem.

The present disclosure has been made to solve the above problem, and an object of the present disclosure is to provide a noise filter, a power conversion system, and a management system that can achieve high reliability.

### Means to Solve the Problem

A noise filter according to the present disclosure is a noise filter provided on one of an electric path connecting an AC or DC power supply and a power conversion device which converts power outputted from the AC or DC power supply to AC or DC power, or an electric path connecting the power conversion device and a load, the noise filter including: a noise detection unit which detects common mode noise occurring during operation of the power conversion device; a cancellation signal generation unit which generates a cancellation signal for canceling out the common mode noise; a cancellation signal injection unit which injects the cancellation signal into the electric path; and an abnormality detection unit which outputs an abnormality detection signal in a case where it is detected that the cancellation signal is abnormal. An abnormality processing sequence is executed on the basis of the abnormality detection signal.

A power conversion system according to the present disclosure includes: a power conversion device which converts power outputted from an AC or DC power supply to AC or DC power; and the noise filter described above.

A management system according to the present disclosure includes: a power conversion device which converts power outputted from an AC or DC power supply to AC or DC power; the noise filter described above, the noise filter further including a communication unit which is connected to a cancellation signal output unit composing the noise filter and transmits data to outside; and a management device having a database for storing the data transmitted from the communication unit, and a data analysis unit which analyzes the data.

### Effect of the Invention

The noise filter and the power conversion system according to the present disclosure operate stably even in a case where abnormality has occurred in the cancellation signal, and thus provide an effect of achieving high reliability.

The management system according to the present disclosure has the management device which performs data analysis using data transmitted from the power conversion system, whereby it becomes possible to swiftly cope with a cause for abnormality, thus providing an effect of further improving reliability of the power conversion system and also providing an effect of improving ease of management and maintenance for the power conversion system.

### BRIEF DESCRIPTION OF THE DRAWINGS

FIG. 1 is a system configuration diagram showing a power conversion system according to embodiment 1;

FIG. 2 is a circuit configuration diagram showing a power conversion device forming a part of the power conversion system according to embodiment 1;

FIG. 3 illustrates common mode noise occurring in the power conversion system according to embodiment 1;

FIG. 4 is a configuration diagram showing a noise filter and the power conversion system according to embodiment 1;

FIG. 5A is a configuration diagram showing an example of a noise detection unit in the noise filter according to embodiment 1;

FIG. 5B is a configuration diagram showing an example of a noise detection unit in the noise filter according to embodiment 1;

FIG. 6 is a configuration diagram showing an example of a cancellation signal generation unit in the noise filter according to embodiment 1;

FIG. 7 is a configuration diagram showing an example of an abnormality detection unit in the noise filter according to embodiment 1;

FIG. 8 is a configuration diagram showing an example of a feature quantity detection unit in the noise filter according to embodiment 1;

FIG. 9 is a configuration diagram showing an example of a feature quantity comparison unit in the noise filter according to embodiment 1;

FIG. 10 is a configuration diagram showing a cancellation signal injection unit in the noise filter according to embodiment 1;

FIG. 11 is an example of a hardware configuration diagram for implementing the noise filter and the power conversion system according to embodiment 1;

FIG. 12A illustrates a behavior in normal operation of an injection transformer in the noise filter according to embodiment 1;

FIG. 12B shows the relationship between an impedance and a frequency of the injection transformer in normal operation in the noise filter according to embodiment 1;

FIG. 13A illustrates a behavior in protection operation of the injection transformer in the noise filter according to embodiment 1;

FIG. 13B shows the relationship between an impedance and a frequency in protection operation of the injection transformer in the noise filter according to embodiment 1;

FIG. 14 is a configuration diagram showing an example of a protection circuit in the noise filter according to embodiment 1;

FIG. 15 is a configuration diagram showing a noise filter according to embodiment 2;

FIG. 16 is a configuration diagram showing another configuration example of the noise filter according to embodiment 2;

FIG. 17 illustrates an example of processing on an abnormality detection signal in a cancellation signal output unit in the noise filter according to embodiment 2;

FIG. 18 is a configuration diagram showing a power conversion system according to embodiment 3;

FIG. 19 illustrates common mode noise occurring in the power conversion system according to embodiment 3;

FIG. 20 is a configuration diagram showing a noise filter according to embodiment 3;

FIG. 21 relates to control response of a main circuit section of the noise filter, in which FIG. 21A shows control response in a case of not having a filter unit, FIG. 21B shows a pass characteristic of the filter unit, and FIG. 21C shows control response in a case of having the filter unit;

FIG. 22 relates to control response of the noise filter, in which FIG. 22A shows a gain characteristic and FIG. 22B shows a phase characteristic;

FIG. 23 relates to control response of the noise filter, in which FIG. 23A shows change in the gain characteristic in a case where the control characteristic has changed due to occurrence of abnormality, and FIG. 23B shows change in the phase characteristic in a case where the control characteristic has changed due to occurrence of abnormality;

FIG. 24 shows an abnormal output waveform of the cancellation signal output unit of the noise filter;

FIG. 25A shows the waveform of common mode voltage in a normal case, FIG. 25B shows the waveform of common mode current in a normal case, FIG. 25C shows the waveform of output voltage of a cancellation signal in a normal case in the noise filter, and FIG. 25D shows the waveform of output current of the cancellation signal in a normal case in the noise filter;

FIG. 26A shows the waveform common mode voltage in an abnormal case, FIG. 26B shows the waveform of common mode current in an abnormal case, FIG. 26C shows the waveform of output voltage of a cancellation signal in an abnormal case, and FIG. 26D shows the waveform of output current of the cancellation signal in an abnormal case;

FIG. 27 is a configuration diagram showing a noise filter and a power conversion system according to embodiment 4;

FIG. 28 is a configuration diagram showing a management system according to embodiment 5;

FIG. 29 is a configuration diagram showing a noise filter and a power conversion system according to embodiment 5;

FIG. 30 is a configuration diagram showing a noise filter and a power conversion system according to embodiment 6.

### DESCRIPTION OF EMBODIMENTS

Hereinafter, a noise filter according to embodiments of the present disclosure will be described in detail with reference to the drawings. In the drawings, the same reference characters denote the same or corresponding parts.

### Embodiment 1

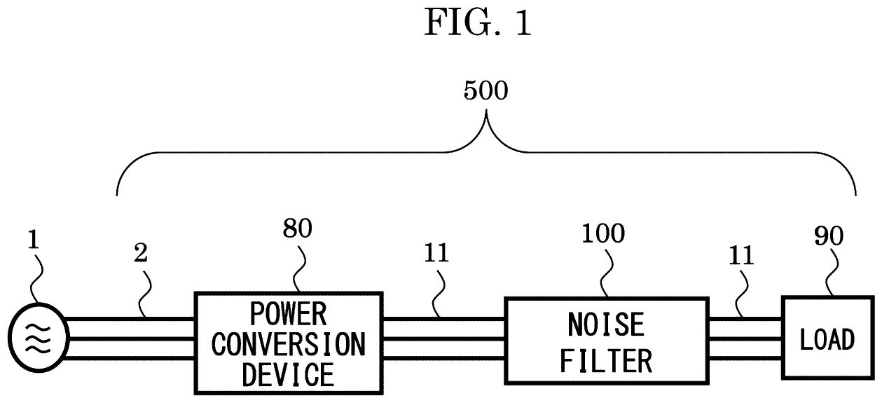

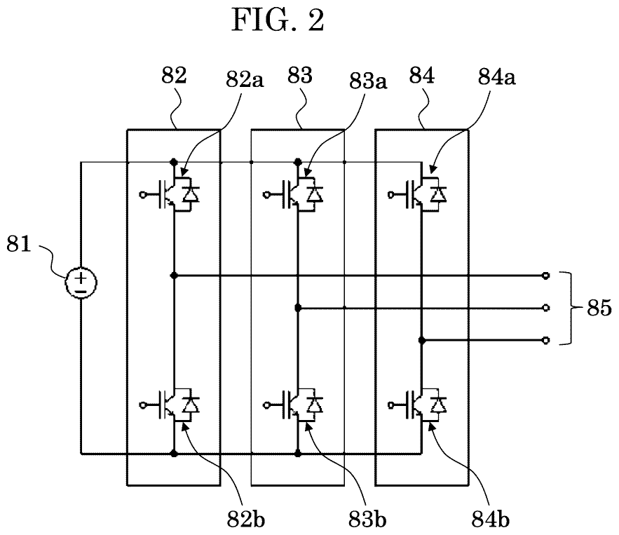

A noise filter 100 and a power conversion system 500 according to embodiment 1 will be described with reference to FIG. 1 to FIG. 11. FIG. 1 is a system configuration diagram showing a power conversion system 500 according to embodiment 1, and FIG. 2 is a circuit configuration diagram showing a power conversion device 80 forming a part of the power conversion system 500 according to embodiment 1.

The power conversion system 500 includes the power conversion device 80 which is provided between an AC power supply 1 and a load 90 and converts input power from the AC power supply 1 to desired DC power or AC power, the load 90 which is supplied with the desired DC power or AC power from the power conversion device 80, and a noise filter 100 which is provided on an electric path 11 connecting the power £ conversion device 80 and the load 90. The input power from the AC power supply 1 is inputted to the power conversion device 80 via an electric path 2. The AC power supply 1 is merely an example of a power supply. Instead of the AC power supply 1, a DC power supply may be used, and also in the other embodiments described later, a DC power supply may be used instead of the AC power supply 1.

The power conversion device 80 converts input power inputted from the AC power supply 1 to power needed for driving the load 90, and outputs the converted power.

Although the noise filter 100 is provided between the power conversion device 80 and the load 90 in embodiment 1, the noise filter 100 may be provided on the electric path 2 connecting the AC power supply 1 and the power conversion device 80.

The power conversion device 80 is a two-level three-phase inverter as shown in FIG. 2, for example. That is, two semiconductor switches 82a, 82b connected in series form one upper-lower arm 82. Two semiconductor switches 83a, 83b connected in series form one upper-lower arm 83. Two semiconductor switches 84a, 84b connected in series form one upper-lower arm 84. A DC power supply 81 is connected to the three upper-lower arms 82, 83, 84.

The DC power supply 81 is formed by, for example, a converter that converts AC input power inputted from the AC power supply 1 to DC power. Intermediate points of the three upper-lower arms 82, 83, 84 are connected to inverter output terminals 85. The six semiconductor switches 82a, 82b, 83a, 83b, 84a, 84b perform switching operations, whereby AC power is outputted to the inverter output terminals 85. At this time, the output potential of each inverter output terminal 85 becomes a potential of either positive voltage or negative voltage of the DC power supply 81. Thus, common mode voltage of the power conversion device 80 becomes certain voltage that is not zero.

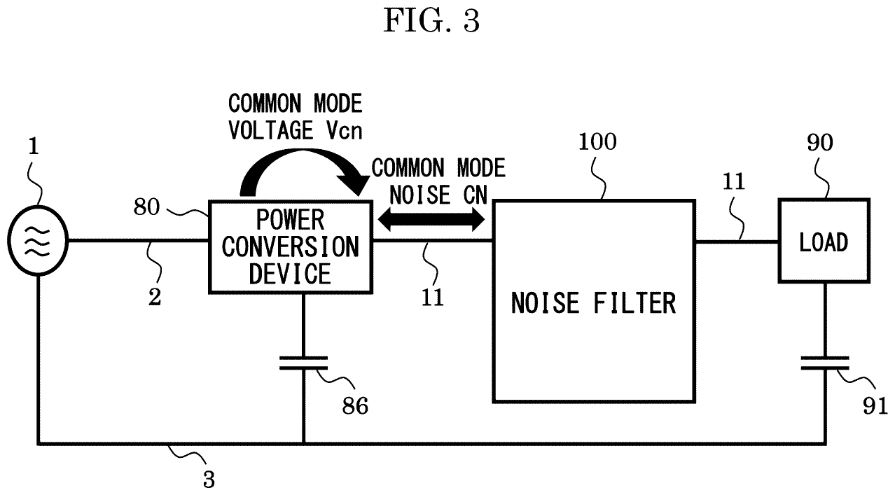

FIG. 3 illustrates common mode noise occurring in the power conversion system 500 according to embodiment 1, and shows a common mode equivalent circuit. In the power conversion system 500, the AC power supply 1 and the load 90 are connected on the ground side via a ground line 3, as well as the electric path 11 described above.

The noise filter 100 is provided with a ground capacitor 15 (not shown) having one end connected to the ground line 3. In addition, a parasitic capacitance 86 is present between the power conversion device 80 and the ground line 3, and a parasitic capacitance 91 is present between the load 90 and the ground line 3. In the power conversion system 500, common mode voltage Von occurring in the power conversion device 80 is applied to a common mode loop passing through the parasitic capacitances 86, 91 and the ground line 3, and therefore common mode current (common mode noise CN) flows in a direction indicated by an arrow in FIG. 3.

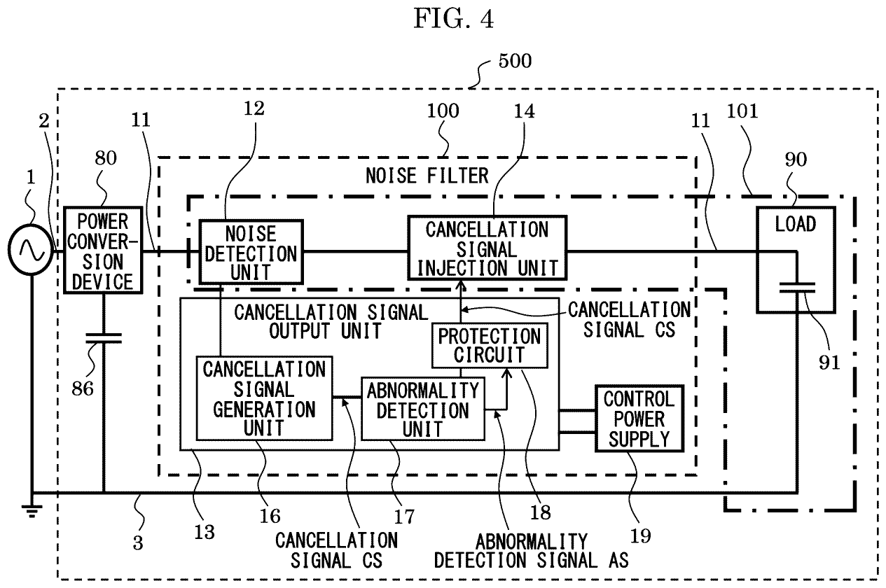

FIG. 4 is a configuration diagram showing the noise filter 100 and the power conversion system 500 according to embodiment 1. The noise filter 100 is interposed between the power conversion device 80 and the load 90. That is, the noise filter 100 is provided on the electric path 11 connecting the power conversion device 80 and the load 90.

The noise filter 100 includes a noise detection unit 12 connected to the electric path 2, a cancellation signal output unit 13 which generates a cancellation signal CS from common mode noise CN (not shown in FIG. 4) detected by the noise detection unit 12 and outputs the cancellation signal CS, a cancellation signal injection unit 14 which is provided on the electric path 11 on the output end side, i.e., on the load 90 side, relative to the noise detection unit 12, and injects the cancellation signal CS outputted from the cancellation signal output unit 13 into the electric path 11, and a control power supply 19 which supplies the cancellation signal output unit 13 with power for generating and injecting the cancellation signal CS.

The cancellation signal output unit 13 includes a cancellation signal generation unit 16 which amplifies a noise detection signal DS outputted from the noise detection unit 12, and an abnormality detection unit 17 which can transmit an output from the cancellation signal generation unit 16 as the cancellation signal CS to the cancellation signal injection unit 14 and output an abnormality detection signal AS on the basis of the output voltage of the cancellation signal generation unit 16.

The cancellation signal output unit 13 further includes a protection circuit 18 which is interposed between the abnormality detection unit 17 and the cancellation signal injection unit 14 and which is an example of connection interruption means that can interrupt injection of the cancellation signal. That is, the noise filter 100 according to embodiment 1 includes connection interruption means which interrupts connection between the cancellation signal output unit 13 and the cancellation signal injection unit 14, as protection means for inhibiting an abnormal cancellation signal CS from being injected into the electric path 11. In embodiment 1, the protection circuit 18 is applied as one example of the connection interruption means.

In embodiment 1, the abnormality detection unit 17 is formed by an element and a circuit that hardly influence the output characteristic, and therefore the output of the cancellation signal generation unit 16 is almost the same as the cancellation signal CS. Therefore, in the following description, unless otherwise specified, the output of the cancellation signal generation unit 16 is referred to as the cancellation signal CS.

A filter unit (not shown) that can adjust the characteristic of the cancellation signal CS may be provided between the noise detection unit 12 and the cancellation signal generation unit 16 or between the cancellation signal generation unit 16 and the abnormality detection unit 17. In a case where the filter unit is provided between the noise detection unit 12 and the cancellation signal generation unit 16, the cancellation signal generation unit 16 amplifies the noise detection signal DS adjusted by the filter unit, to generate the cancellation signal CS. Also in this case, the characteristic of the cancellation signal CS is adjusted through adjustment of the noise detection signal DS.

An example of the above filter unit is an input filter circuit that adjusts the attenuation characteristic of the noise filter 100 by reduction of a gain in a specific band or the like. As specific examples, an analog filter such as a high-pass filter, a low-pass filter, or a notch filter formed by a resistor and a capacitor can be used.

In the noise filter 100, the ground capacitor 15 (not shown) connected between the electric path 11 and the ground line 3 is provided. The noise detection unit 12, the cancellation signal injection unit 14, and the ground capacitor 15 form a main circuit section 101 of the noise filter 100. The control characteristic of the noise filter 100 greatly depends on the main circuit section 101. An inductance value of the main circuit section 101 is the sum of an inductance value of a common mode transformer forming the noise detection unit 12 and an inductance value of a common mode transformer forming the cancellation signal injection unit 14. A capacitance value of the main circuit section 101 is a capacitance value of the ground capacitor 15. In the above description, the case where the load 90 is included inside the power conversion system 500 is described, but the present disclosure is not limited thereto. That is, also in a case where the load 90 is connected outside the power conversion system 500, the main circuit section 101 is formed using a parasitic capacitance 91 serving as a common mode impedance of the load 90. The same applies to the main circuit sections in the other embodiments described later.

The details of the control characteristic of the main circuit section 101 will be described later.

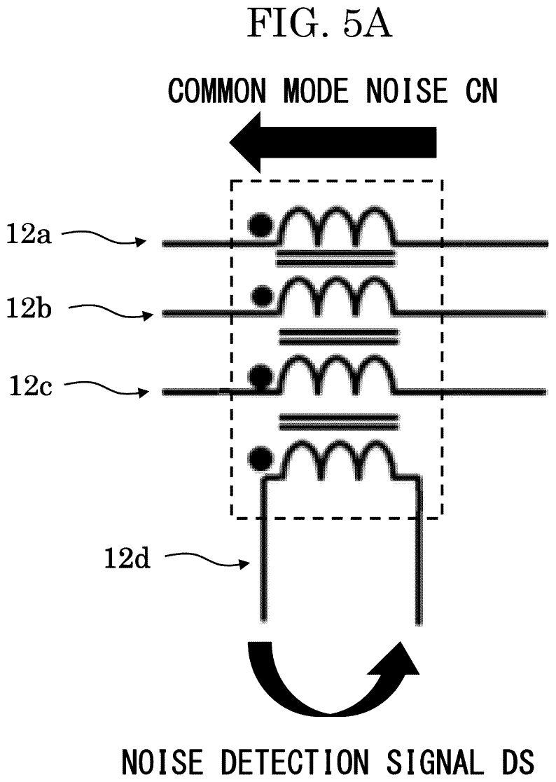

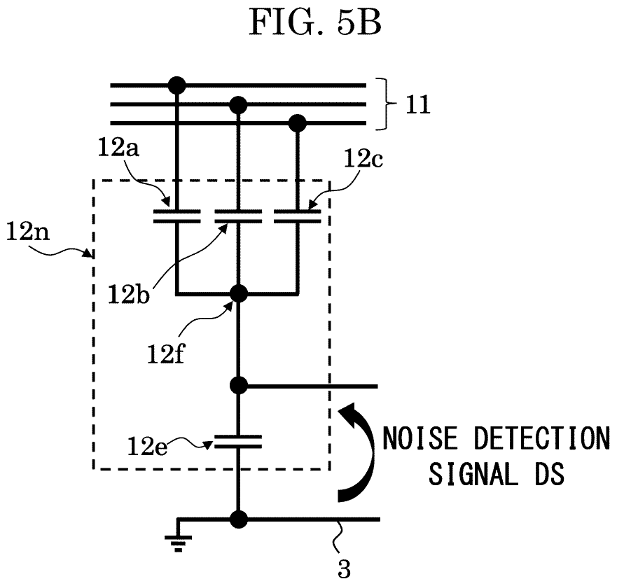

FIG. 5A and FIG. 5B are configuration diagrams showing examples of the noise detection unit 12 in the noise filter 100 according to embodiment 1. As shown in FIG. 5B, the noise detection unit 12 is formed by a capacitor network. Hereinafter, a plurality of capacitors forming the noise detection unit 12 are referred to as a detection capacitor network 12n.

The detection capacitor network 12n includes a detection capacitor 12a connected to a U-phase power line, a detection capacitor 12b connected to a V-phase power line, and a detection capacitor 12c connected to a W-phase power line of the electric path 11 connecting the power conversion device 80 and the load 90, and includes a detection capacitor 12e provided between the ground line 3 and a star connection point 12f connected to other terminals of the detection capacitors 12a, 12b, 12c opposite to the power lines. As shown in FIG. 5B, the detection capacitor network 12n operates as a noise detector for dividing and detecting the common mode voltage.

The detection ratio of the common mode voltage in the detection capacitor network 12n is determined by the ratio between the parallel impedance of the detection capacitors 12a, 12b, 12c and the impedance of a detection capacitor 12e. Therefore, in the noise detection unit 12, the noise detection signal DS is generated between both ends of a T-phase winding 12d by the common mode noise CN applied to the detection capacitor network 12n.

Both ends of the T-phase winding 12d are connected to the cancellation signal generation unit 16. That is, the noise detection signal DS generated between both ends of the T-phase winding 12d is transmitted to the cancellation signal generation unit 16. The detection capacitor network 12n has an impedance sufficiently higher than the parasitic capacitance 86 of the inverter and the parasitic capacitance 91 of the load 90 in the common mode equivalent circuit shown in FIG. 3, and thus has a relatively high impedance to the ground. Therefore, the detection capacitor network 12n does not have an adverse influence on leakage current of the power conversion device 80.

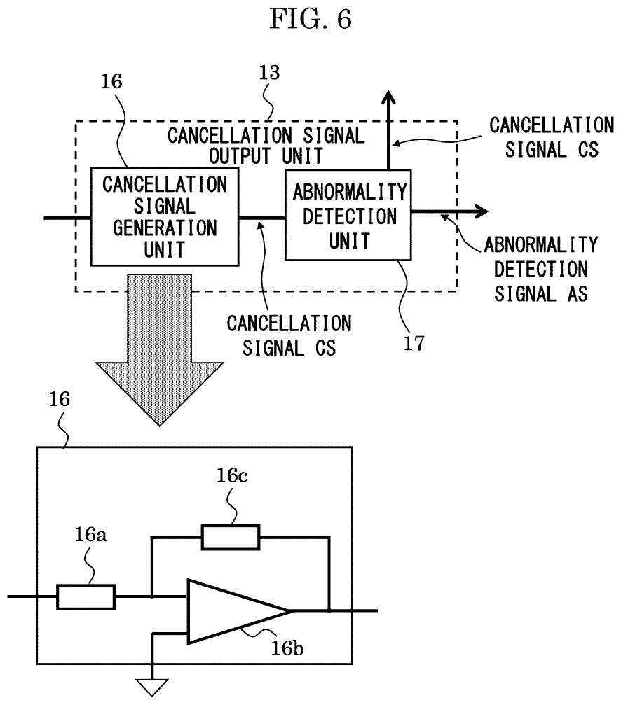

FIG. 6 is a configuration diagram showing an example of the cancellation signal generation unit 16 in the noise filter 100 according to embodiment 1. The cancellation signal generation unit 16 includes an input resistor 16a, an operational amplifier 16b, and a feedback resistor 16c. An inverting input terminal of the operational amplifier 16b is connected to the input terminal side (left side in FIG. 6) of the cancellation signal generation unit 16 via the input resistor 16a.

The inverting input terminal of the operational amplifier 16b is connected to an output terminal of the operational amplifier 16b via the feedback resistor 16c. A non-inverting input terminal of the operational amplifier 16b is grounded. The cancellation signal generation unit 16 shown in FIG. 6 is an inverting amplifier circuit using the operational amplifier 16b, but may be a non-inverting amplifier circuit. The cancellation signal generation unit 16 amplifies the noise detection signal DS at an amplification factor which is given by the ratio between a resistance value of the input resistor 16a and a resistance value of the feedback resistor 16c, to generate the cancellation signal CS, and outputs the cancellation signal CS.

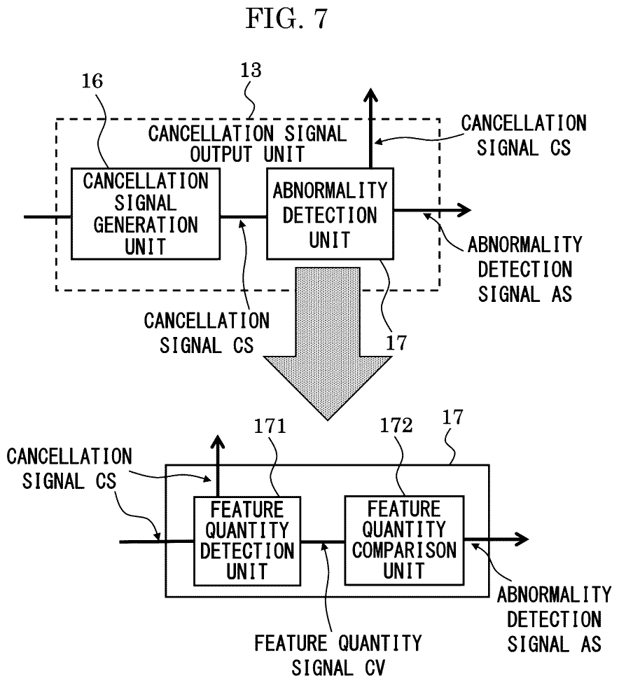

FIG. 7 is a configuration diagram showing an example of the abnormality detection unit 17 in the noise filter 100 according to embodiment 1. The abnormality detection unit 17 includes a feature quantity detection unit 171 which outputs a feature quantity signal CV for detecting abnormality using output voltage of the cancellation signal CS, and a feature quantity comparison unit 172 which generates the abnormality detection signal AS by performing predetermined calculation on the feature quantity signal CV and outputs the abnormality detection signal AS. In embodiment 1, in a case where abnormality of the noise filter 100 is detected, the abnormality detection signal AS is outputted as ON, and on the other hand, in a case where abnormality is not detected, the abnormality detection signal AS is outputted as OFF.

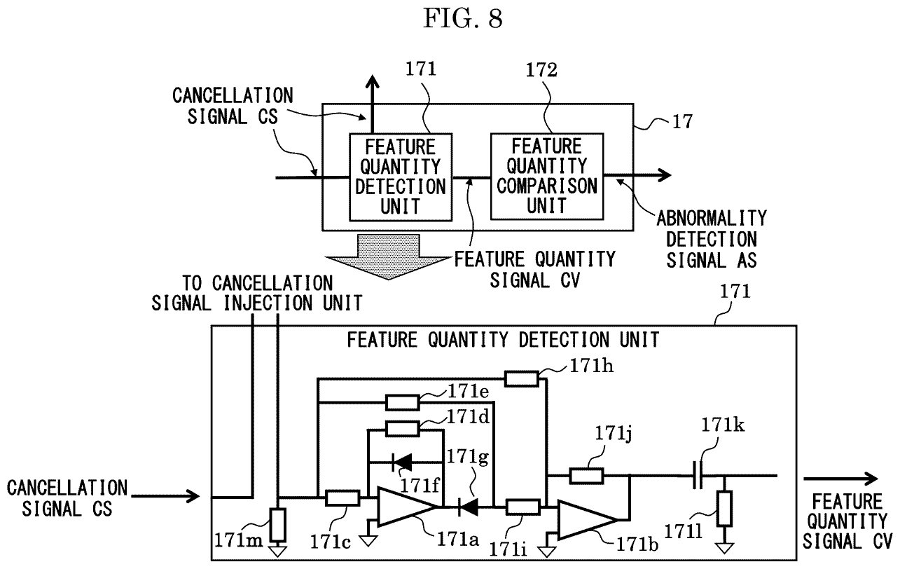

FIG. 8 is a configuration diagram showing an example of the feature quantity detection unit 171 which is a part of the abnormality detection unit 17 in the noise filter 100 according to embodiment 1. The feature quantity detection unit 171 generates the feature quantity signal CV on the basis of a voltage value of output voltage of the cancellation signal CS, and outputs the feature quantity signal CV. The feature quantity signal CV is a signal representing a feature quantity to be used for abnormality detection. For a value to be used as the feature quantity, various values are conceivable.

In the example of the feature quantity detection unit 171 shown in FIG. 8, the feature quantity detection unit 171 has a configuration for a case of using a voltage average value of output voltage of the cancellation signal CS as the feature quantity. As shown in FIG. 8, the feature quantity detection unit 171 is configured such that a low-pass filter formed by a capacitor 171k and a resistor 1711 is connected to an output side of an absolute value detection circuit formed by operational amplifiers 171a, 171b, resistors 171c, 171d, 171e, 171h, 171l, 171j, 171m, and diodes 171f, 171g.

The feature quantity detection unit 171 has an input terminal (not shown) connected to an output terminal (not shown) of the cancellation signal generation unit 16, and output voltage of the cancellation signal CS outputted from the cancellation signal generation unit 16 is inputted as an input signal to the feature quantity detection unit 171. With the input signal inputted to the absolute value detection circuit described above, an absolute value of the voltage value of output voltage of the cancellation signal CS is outputted from the absolute value detection circuit.

Since the output of the absolute value detection circuit is averaged by the low-pass filter, a voltage average value of output voltage of the cancellation signal CS is outputted from the low-pass filter described above. That is, the output of the feature quantity detection unit 171 is the voltage average value of output voltage of the cancellation signal CS. The output of the feature quantity detection unit 171 is outputted as the feature quantity signal CV to the feature quantity comparison unit 172. The circuit of the feature quantity detection unit 171 is not limited to the example shown in FIG. 8, and may be freely configured without deviating from the scope of the present disclosure.

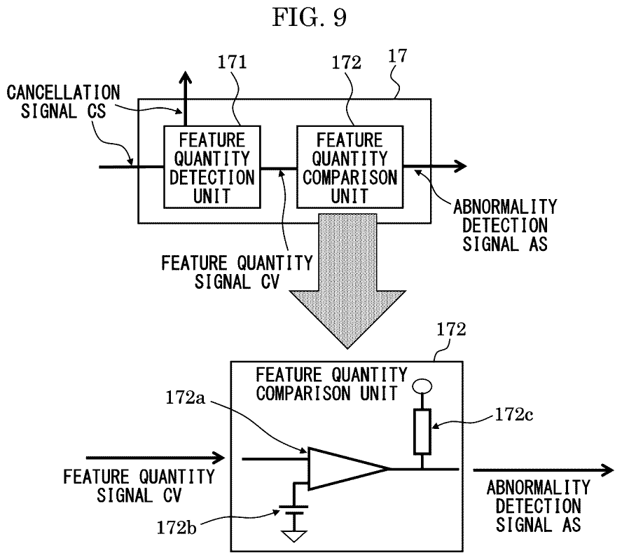

FIG. 9 is a configuration diagram showing an example of the feature quantity comparison unit 172 which is a part of the abnormality detection unit 17 in the noise filter 100 according to embodiment 1. The feature quantity comparison unit 172 generates the abnormality detection signal AS by performing predetermined calculation on the feature quantity signal CV outputted from the feature quantity detection unit 171, and outputs the generated abnormality detection signal AS.

FIG. 9 shows an example in which the feature quantity comparison unit 172 in the noise filter 100 according to embodiment 1 is configured using a comparator circuit for comparing the feature quantity signal CV with predetermined threshold voltage. The feature quantity comparison unit 172 includes a comparator 172a, a DC voltage source 172b, and a pull-up resistor 172c. An inverting input terminal of the comparator 172a is connected to the input terminal side (left side in FIG. 9) of the feature quantity comparison unit 172. A non-inverting input terminal of the comparator 172a is connected to a positive electrode of the DC voltage source 172b. A negative electrode of the DC voltage source 172b is grounded. An output terminal of the comparator 172a is connected to the output terminal side of the feature quantity comparison unit 172. The pull-up resistor 172c is connected between the output terminal of the comparator 172a and the output terminal of the feature quantity comparison unit 172.

When the feature quantity signal CV is inputted as an input signal to the feature quantity comparison unit 172, the magnitude of voltage of the feature quantity signal CV and the magnitude of voltage of the DC voltage source 172b are compared with each other, and the abnormality detection signal AS is outputted in accordance with a result of comparison. Specifically, for example, in a case where voltage of the feature quantity signal CV is greater than voltage of the DC voltage source 172b, abnormality is detected and thus the abnormality detection signal AS is outputted as ON. In this case, the voltage value of the DC voltage source 172b serves as threshold voltage for determination as to whether or not there is abnormality. The circuit forming the feature quantity comparison unit 172 is not limited to the example shown in FIG. 9, and may be freely configured without deviating from the scope of the present disclosure.

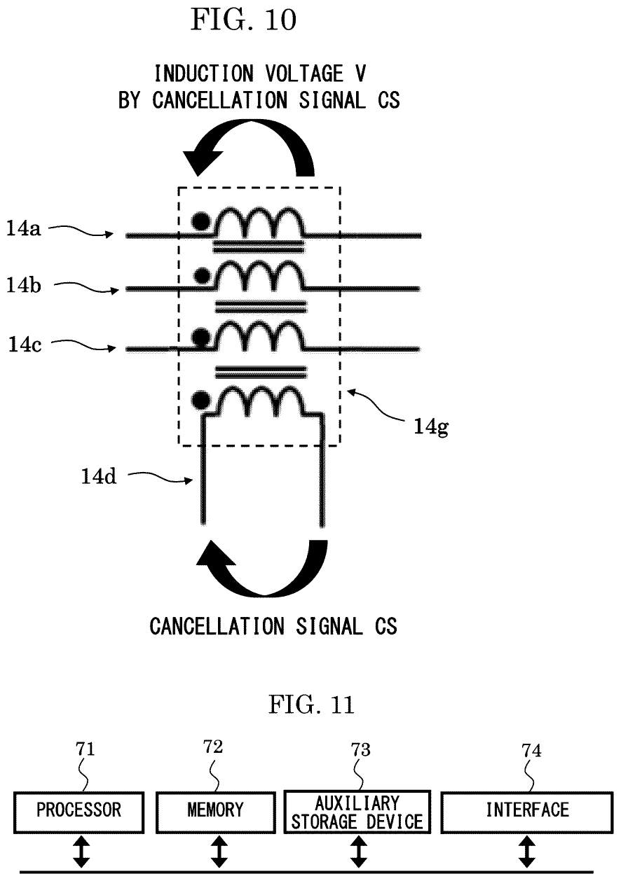

FIG. 10 is a configuration diagram showing the cancellation signal injection unit 14 in the noise filter 100 according to embodiment 1. The cancellation signal injection unit 14 is formed by a common mode transformer. The common mode transformer forming the cancellation signal injection unit 14 is referred to as an injection transformer 14g. The injection transformer 14g includes, on the electric path 11, an R-phase winding 14a wound around an R-phase power line, an S-phase winding 14b wound around an S-phase power line, a T-phase winding 14c wound around a T-phase power line, and an injection winding 14d. The R-phase winding 14a, the S-phase winding 14b, and the T-phase winding 14c are wound in the same phase. The injection transformer 14g configured as described above has a high inductance value only for a common mode, and thus works as a common mode choke coil.

In the cancellation signal injection unit 14 formed by the injection transformer 14g as described above, when the cancellation signal CS is inputted between both ends of the injection winding 14d, the cancellation signal CS inputted to the injection winding 14d induces induction voltage V for canceling the common mode noise CN, on the R-phase winding 14a, the S-phase winding 14b, and the T-phase winding 14c.

A hardware configuration for implementing a control system according to embodiment 1 may be formed by an analog circuit as shown in FIG. 8 and FIG. 9, but here, an example different from the analog circuit will be described.

FIG. 11 is an example of a hardware configuration diagram for implementing a control system of the noise filter 100 according to embodiment 1. Here, the “control system” refers to overall control of the noise filter 100 including, in particular, the control power supply 19. The control system of the noise filter 100 according to embodiment 1 is mainly composed of a processor 71, a memory 72 as a main storage device, an auxiliary storage device 73, and an interface 74.

The processor 71 is formed by, for example, a central processing unit (CPU), an application specific integrated circuit (ASIC), a digital signal processor (DSP), a field programmable gate array (FPGA), and the like.

The memory 72 is formed by a volatile storage device such as a random access memory, and the auxiliary storage device 73 is formed by a nonvolatile storage device such as a flash memory, a hard disk, or the like. The auxiliary storage device 73 stores a predetermined program to be executed by the processor 71. The processor 71 reads and executes the program as appropriate, to perform various calculation processes. At this time, the predetermined program is temporarily stored into the memory 72 from the auxiliary storage device 73, and the processor 71 reads the program from the memory 72.

Various calculation processes in the control system of the noise filter 100 and the power conversion system 500 according to embodiment 1 are implemented by the processor 71 executing the predetermined program as described above.

Results of calculation processes by the processor 71 are stored into the memory 72 once, and then are stored into the auxiliary storage device 73 in accordance with the purpose of the executed calculation process. As described above, means for implementing the control system may be formed by an analog circuit or a digital circuit.

A problem that occurs in a control device of the noise filter 100 in a case where abnormality has occurred, e.g., a command value for the power conversion device 80 which is a controlled device temporarily becomes abnormal, a winding of the injection coils becomes abnormal, and a component such as a transistor or a power supply capacitor of a control circuit fails, will be described below.

In order to stop noise cancellation operation for the purpose of protecting the control device from overcurrent or overvoltage of the control device and protecting the controlled device from increase in path noise, it is necessary to perform protection operation of cutting off connection between the cancellation signal generation unit 16 and the cancellation signal injection unit 14.

In a case of performing the protection operation, when connection between the cancellation signal generation unit 16 and the cancellation signal injection unit 14 is cut off, a low output impedance of the cancellation signal generation unit 16 is not connected on the auxiliary winding connected to the control circuit side of the injection transformer 14g forming the cancellation signal injection unit 14, so that an interposition impedance of the injection transformer 14g forming the cancellation signal injection unit 14 which is a part of the main circuit section 101 significantly increases. At this time, the injection transformer 14g serves as a common mode choke coil with main windings having the same number of turns, and thus has a great inductance component. As a result, the resonant frequency between the injection transformer 14g and a load common mode capacitance changes.

When the resonant frequency between the injection transformer 14g and the load common mode capacitance changes, the changed resonant frequency of the common mode path overlaps a switching frequency of the power conversion device 80 and a harmonic frequency thereof, so that, on the contrary, the common mode noise CN might sharply increase.

In order to avoid increase in the common mode noise CN, it is necessary to increase an inductance component of the injection transformer 14g in protection operation by selecting the injection transformer 14g having a large number of winding turns so that the resonant frequency in protection operation becomes lower than the switching frequency in advance. However, increase in the number of winding turns of the injection transformer 14g leads to size increase of the noise filter 100 and therefore is not preferable.

Another problem that occurs in protection operation in terms of voltage allocation will be described below.

Common mode voltage on the load side as seen from the power conversion device 80 which is a noise source is allocated in accordance with the impedance ratio of the main circuit section 101 shown in FIG. 4. When connection between the cancellation signal generation unit 16 and the cancellation signal injection unit 14 is cut off, the low output impedance of the cancellation signal generation unit 16 is not connected on the auxiliary winding connected to the control circuit side of the injection transformer 14g, so that the interposition impedance of the injection transformer 14g forming the cancellation signal injection unit 14 which is a part of the main circuit section 101 significantly increases.

As a result of significant increase in the interposition impedance of the injection transformer 14g, common mode voltage passively allocated to the injection transformer 14g from the common mode noise CN shown in FIG. 3 significantly increases, and this might cause magnetic saturation of a core. Due to occurrence of magnetic saturation, a problem such as heat generation, noise, or vibration arises. Therefore, it is necessary to avoid magnetic saturation, but meanwhile, size increase of the core leads to size increase of the noise filter 100, which is not preferable.

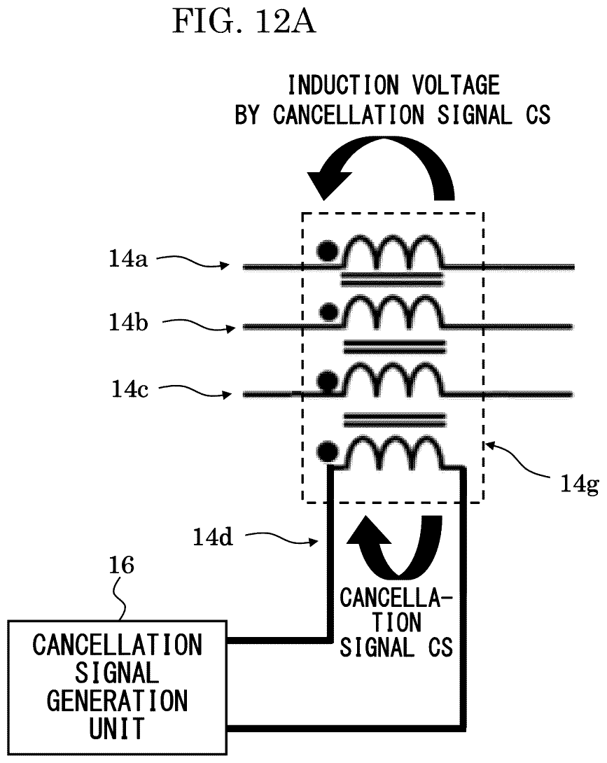

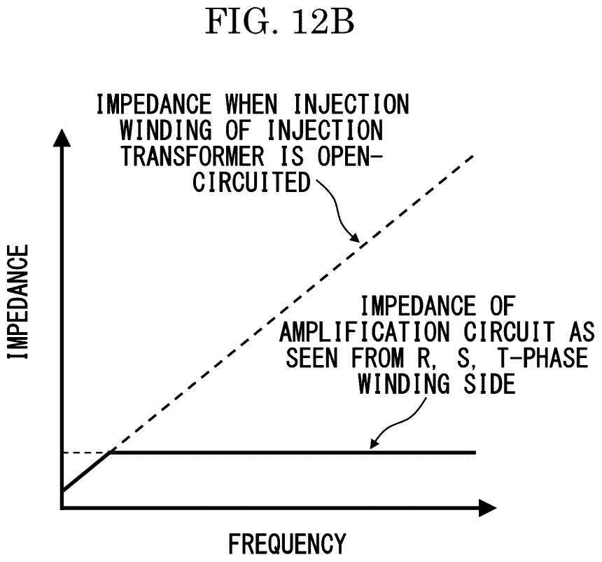

With reference to FIG. 12A and FIG. 12B, the interposition impedance of the injection transformer 14g forming the cancellation signal injection unit 14 in normal noise cancellation operation will be described. FIG. 12A illustrates a behavior in normal operation of the injection transformer 14g in the noise filter 100 according to embodiment 1, and FIG. 12B shows the relationship between an impedance and a frequency in normal operation of the injection transformer 14g in the noise filter 100 according to embodiment 1.

As shown in FIG. 12A, in normal noise cancellation operation, the cancellation signal generation unit 16 which has a low output impedance is connected to the injection winding 14d of the injection transformer 14g, and the cancellation signal injection unit 14 injects the cancellation signal CS into the electric path 11. In this case, for example, the interposition impedance of the injection transformer 14g on the common mode path is reduced to a low value corresponding to the impedance of the amplification circuit, as shown in FIG. 12B. Therefore, in a frequency band in which the common mode noise CN occurs, the resonant frequency of the common mode path is not influenced, and since voltage allocation based on the common mode voltage is small, magnetic saturation of the injection transformer 14g due to passive voltage allocation by the impedance does not occur.

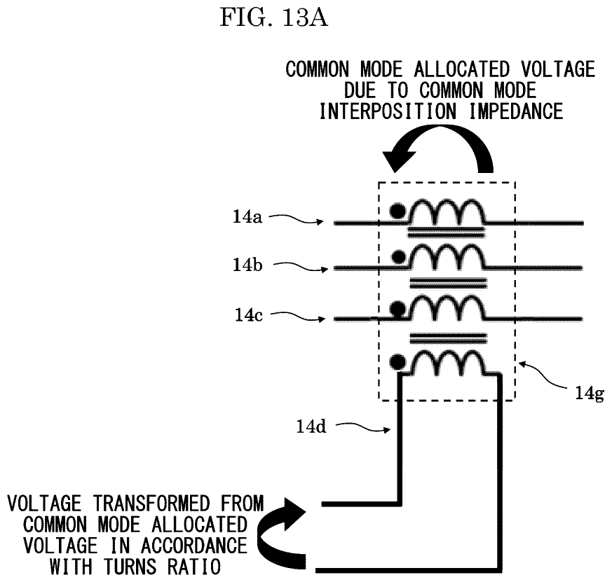

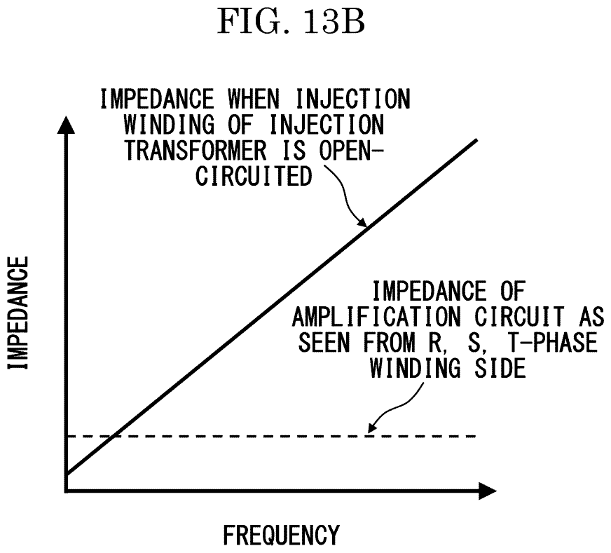

With reference to FIG. 13A and FIG. 13B, the interposition impedance of the injection transformer 14g forming the cancellation signal injection unit 14 in protection operation will be described. FIG. 13A illustrates a behavior in protection operation of the injection transformer 14g in the noise filter 100 according to embodiment 1, and FIG. 13B shows the relationship between an impedance and a frequency in protection operation of the injection transformer 14g in the noise filter 100 according to embodiment 1. As shown in FIG. 13A, the injection winding 14d is open-circuited in protection operation. In other words, this state corresponds to a state in which a high open-circuited impedance is connected to the injection winding 14d.

In this case, the injection transformer 14q has an inductance component as a common mode choke coil in accordance with a core permeability, a magnetic path length, a sectional area, and the number of turns of the injection transformer 14g as shown in FIG. 13B, for example, and therefore serves as an inductive impedance due to the inductance component, thus greatly influencing the resonant frequency of the common mode path. Further, in a band in which the common mode noise CN occurs, voltage allocation due to common mode voltage greatly increases, so that magnetic saturation of the injection transformer 14g might occur as described above.

The abnormality detection unit 17 connected between the cancellation signal generation unit 16 and the cancellation signal injection unit 14 outputs the abnormality detection signal AS on the basis of one or both of voltage and current of the cancellation signal CS from the cancellation signal generation unit 16.

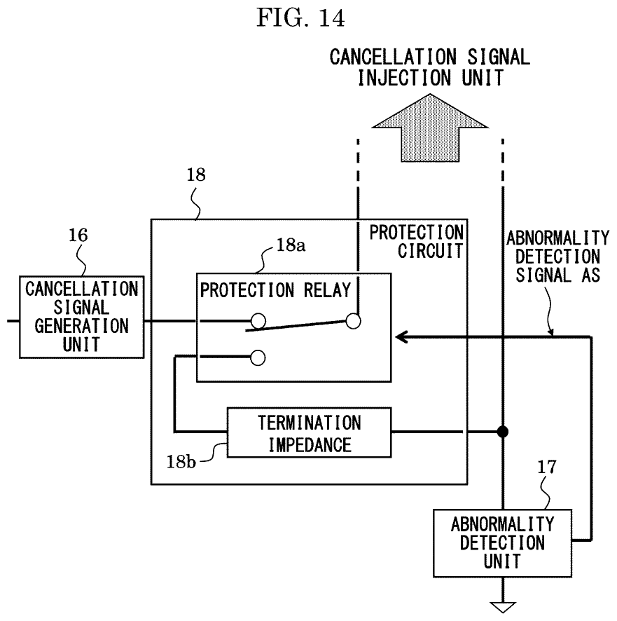

FIG. 14 is a configuration diagram showing the protection circuit 18 of the noise filter 100 according to embodiment 1. A protection relay 18a composing the protection circuit 18 is configured to, through switchover of a relay contact based on the abnormality detection signal AS, switch between two states, i.e., a noise cancellation operation state in which the cancellation signal injection unit 14 and the cancellation signal generation unit 16 are connected, and a noise cancellation stopped state in which the cancellation signal injection unit 14 and the cancellation signal generation unit 16 are cut off from each other and the cancellation signal injection unit 14 and a termination impedance 18b are connected.

In FIG. 14, the protection relay 18a is shown as a form-C single relay. However, the protection relay 18a may be formed by combination of different form-A and form-B relays, or may be formed by a semiconductor-type relay instead of a mechanical relay. The logic of the protection relay 18a in connection may be such that a normally-open contact is connected to the cancellation signal generation unit 16 and a normally-closed contact is connected to the termination impedance 18b, or may be configured conversely.

The protection relay 18a as shown in FIG. 14 is provided, and when protection operation is performed, the auxiliary winding of the injection transformer 14g forming the cancellation signal injection unit 14 is appropriately connected to the termination impedance 18b, whereby it is possible to suppress problems such as change in the resonant frequency of the common mode path and core magnetic saturation of the injection transformer 14g described above.

As described above, the feature quantity detection unit 171 outputs a voltage effective value of output voltage of the cancellation signal CS as the feature quantity signal CV. Further, the DC voltage source 172b of the feature quantity comparison unit 172 provides threshold voltage for determining whether or not there is abnormality with respect to the output voltage value of the cancellation signal CS.

That is, the output voltage value of the DC voltage source 172b is threshold voltage Vth for the voltage effective value. Thus, comparison between the voltage effective value of output voltage of the cancellation signal CS and the threshold voltage Vth for the voltage effective value is performed by the feature quantity comparison unit 172.

If the voltage effective value of output voltage of the cancellation signal CS is greater than the threshold voltage Vth, the output of the comparator 172a becomes high, so that the feature quantity comparison unit 172 outputs the abnormality detection signal AS, as ON. On the other hand, if the voltage effective value of output voltage of the cancellation signal CS is not greater than the threshold voltage Vth, the output of the comparator 172a becomes low, so that the feature quantity comparison unit 172 outputs the abnormality detection signal AS, as OFF.

In the noise filter 100 according to embodiment 1, the abnormality detection signal AS outputted from the feature quantity comparison unit 172 is inputted to the protection circuit 18. As shown in FIG. 14, the protection circuit 18 is typically formed by a form-C control relay.

The protection circuit 18 cuts off the control power supply 19 and the cancellation signal output unit 13 from each other on the basis of the abnormality detection signal AS, interrupts connection between the cancellation signal output unit 13 and the cancellation signal injection unit 14, and connects the cancellation signal injection unit 14 and the termination impedance 18b. Through such operation of the cancellation signal output unit 13, injection of the cancellation signal CS into the electric path 11 is interrupted, whereby the cancellation signal CS having an abnormal output waveform can be prevented from being injected into the electric path 11, and change in the resonant frequency of the common mode path and occurrence of core magnetic saturation of the injection transformer 14g due to change in the interposition impedance of the injection transformer 14g forming the cancellation signal injection unit 14 are suppressed.

After abnormality is detected by the abnormality detection unit 17 and interruption operation by the protection circuit 18 is executed, for example, when the abnormality detection signal AS is outputted as OFF from the feature quantity comparison unit 172, it is assumed that the interruption operation of the protection circuit 18 is reset and generation and injection of the cancellation signal CS are restored. In an abnormal mode in which it is determined in advance that the interruption operation is temporary, restoration operation may be performed after elapse of a predetermine time, using a delay circuit or a counter circuit.

In embodiment 1, the example in which the cancellation signal generation unit 16 is configured as a circuit using the operational amplifier 16b, has been shown. However, the cancellation signal generation unit 16 may be configured as another inverting amplifier circuit or non-inverting amplifier circuit, for example. In the above description, the example in which the protection circuit 18 performs interruption operation in accordance with the abnormality detection signal AS, has been shown. However, for example, interruption operation may be latched or interruption operation may be allowed to be canceled using combination with a reset circuit, thus making it possible to perform operation other than simple interruption operation, by using combination with a logic circuit.

The example in which the feature quantity detection unit 171 is configured as a circuit using an operational amplifier, has been shown. However, for example, a circuit having another configuration for achieving the same purpose may be adopted. The example in which a quantity to be detected by the feature quantity detection unit 171 is a voltage effective value, has been shown. However, the feature quantity detection unit 171 may be configured to detect a different value such as an instantaneous value or an average value, as a feature quantity. In addition, the example in which the feature quantity comparison unit 172 is configured as a circuit using the comparator 172a, has been shown. However, for example, another circuit that can achieve the same purpose may be adopted.

Further, in the noise filter 100 according to embodiment 1, a common mode choke coil other than the noise detection unit 12 and the cancellation signal injection unit 14 may be connected on the electric path 11. The noise detection unit 12 may be formed by a capacitor instead of a common mode transformer.

As described above, the noise filter 100 according to embodiment 1 is characterized in that a process in a case where abnormality has occurred in the cancellation signal CS, i.e., an abnormality processing sequence, is executed. Here, the abnormality processing sequence refers to the following sequences.
(1) A sequence in which the protection circuit 18 is operated on the basis of the abnormality detection signal AS, to interrupt injection of the cancellation signal CS into the electric path and connect both ends of the cancellation signal injection unit 14 to the termination impedance 18b
(2) A sequence in which the power conversion device 80 performs determination for abnormality on the basis of the abnormality detection signal AS, and the switching frequency is changed on the basis of a resonant frequency predicted by a prediction calculation unit provided to the power conversion device 80
(3) A sequence in which the power conversion device 80 performs determination for abnormality on the basis of the abnormality detection signal AS, and the power conversion device 80 is stopped As the abnormality processing sequence, one of the sequences of the above (1) to (3) is executed, for example.

The details of the sequences of (2) and (3) will be described in embodiment 6 later.

The sequences shown above are merely examples of the abnormality processing sequence, and as a matter of course, another processing effective for abnormality may be included.

### Effects of Embodiment 1

As described above, the noise filter 100 and the power conversion system 500 according to embodiment 1 operate stably even in a case where abnormality has occurred in the cancellation signal, thus providing an effect of achieving high reliability.

More specifically, the noise filter includes: the abnormality detection unit which detects abnormality of the noise filter and the power conversion device on the basis of output voltage or output current of the cancellation signal and outputs the abnormality detection signal; and the protection circuit which interrupts connection between the cancellation signal injection unit and the cancellation signal output unit on the basis of the abnormality detection signal and connects the cancellation signal injection unit and the termination impedance. Thus, in a case where some abnormality has occurred so that the noise filter needs to be protected, abnormality is detected from change in output voltage or output current of the cancellation signal which occurs due to the abnormal state, output of the cancellation signal from the cancellation signal output unit to the cancellation signal injection unit is restricted, and the abnormal cancellation signal is prevented from being injected into the electric path. In addition, the termination impedance is connected to the auxiliary winding of the injection transformer forming the cancellation signal injection unit, whereby increase in common mode noise due to unintentional resonance by change in the resonant frequency of the common mode path or occurrence of magnetic saturation due to unintentional increase in the interposition impedance of the injection transformer is prevented. Thus, an effect that the noise filter and the voltage conversion system having high reliability can be achieved is provided.

### Embodiment 2

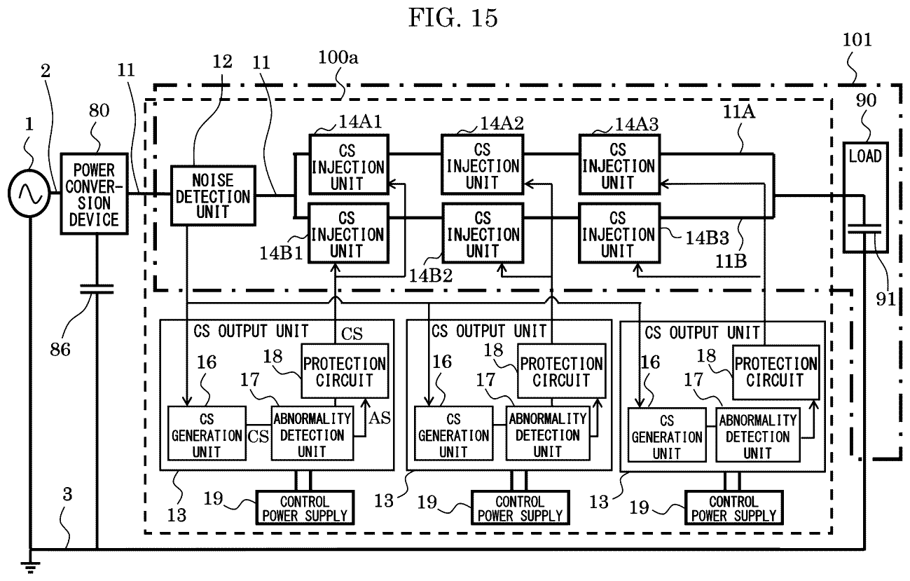

A noise filter 100a according to embodiment 2 will be described with reference to FIG. 15 to FIG. 17. FIG. 15 is a configuration diagram showing the noise filter 100a according to embodiment 2. A difference from embodiment 1 will be mainly described. As the cancellation signal injection unit 14 for injecting the cancellation signal CS outputted from the cancellation signal output unit 13 into the electric path 11, a plurality of cancellation signal injection units are provided and connected in series and parallel. This is because configuring the cancellation signal injection unit 14 in a divided manner can be advantageous in terms of mounting of a core, in particular, in a case where the noise filter 100a is provided between a load and a power conversion device having a large capacity.

FIG. 15 shows a configuration in which the number of series cancellation signal injection units is three and the number of parallel cancellation signal injection units is two, as an example of the noise filter 100a. The cancellation signal injection unit 14 is composed of cancellation signal injection units 14A1, 14A2, 14A3 provided on one electric path 11A of electric paths arranged in parallel and cancellation signal injection units 14B1, 14B2, 14B3 provided on another electric path 11B of the electric paths arranged in parallel.

The cancellation signal output unit 13 has the control power supply 19 which supplies the cancellation signal output unit 13 with power for generating and injecting the cancellation signal CS, and the protection circuit 18 which is interposed between the control power supply 19 and the cancellation signal output unit 13 and can, in protection operation, prevent injection of the cancellation signal CS into the electric paths 11A, 11B and make connection to the termination impedance 18b, and the cancellation signal output unit 13 is provided on a one-by-one basis of the number of series cancellation signal injection units 14. That is, the noise filter 100a includes the cancellation signal output units 13 whose number is the same as the number of series cancellation signal injection units 14.

That is, the noise filter 100a is configured such that a plurality of cancellation signal injection units are provided, the plurality of cancellation signal injection units arranged in series are arranged in parallel on the electric path, and the numbers of the plurality of cancellation signal injection units are the same between parallel arrangements.

Operation of each protection circuit in protection operation in the noise filter 100a will be described. In the noise filter 100a configured as shown in FIG. 15, when protection operation is performed in the cancellation signal output unit 13, the cancellation signal injection units 14Al, 14B1 are subjected to the protection operation so as to be connected to the termination impedance 18b provided for each. In this case, the numbers of the interposed cancellation signal injection units 14 are kept the same between the electric path 11A and the electric path 11B.

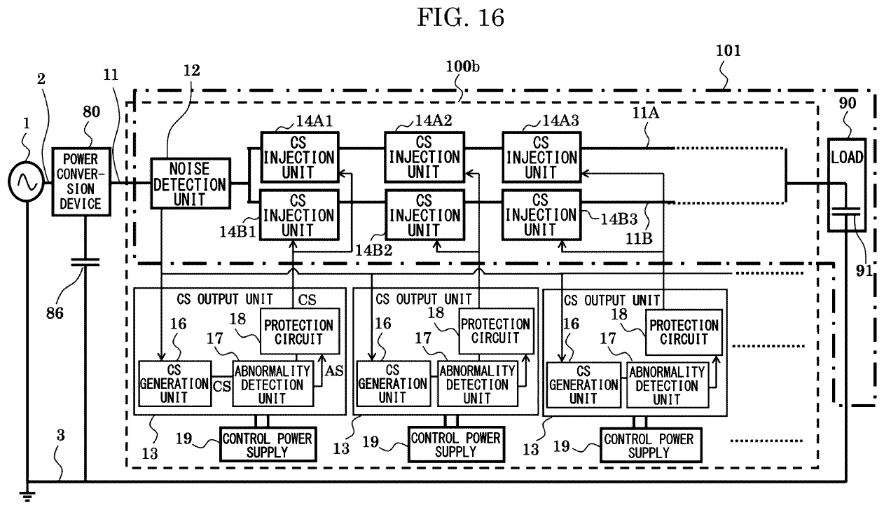

FIG. 16 is a configuration diagram showing a noise filter 100b which is another example of the noise filter according to embodiment 2. A difference from embodiment 1 and the noise filter 100a according to embodiment 2 shown in FIG. 15 will be mainly described.

In the noise filter 100b according to embodiment 2, as the cancellation signal injection unit 14 for injecting the cancellation signal CS outputted from the cancellation signal output unit 13 into the electric path 11, a plurality of cancellation signal injection units are provided and connected in series and parallel. The cancellation signal injection units 14 of the noise filter 100b are provided such that, as an example, the number of series cancellation signal injection units is N and the number of parallel cancellation signal injection units is two, similarly to the configuration shown in FIG. 15.

That is, the noise filter 100b includes cancellation signal injection units 14A1, 14A2, 14A3, . . . , 14AN provided on one electric path 11A of electric paths arranged in parallel, and cancellation signal injection units 14B1, 14B2, 14B3, . . . , 14BN provided on another electric path 11B of the electric paths arranged in parallel. The series number N may be determined as appropriate on the basis of a characteristic required for the noise filter 100b and a characteristic required for the power conversion system.

The cancellation signal output unit 13 has the control power supply 19 which supplies the cancellation signal output unit 13 with power for generating and injecting the cancellation signal CS, and the protection circuit 18 which is interposed between the control power supply 19 and the cancellation signal output unit 13 and can, in protection operation, prevent injection of the cancellation signal CS and make connection to the termination impedance 18b, and such cancellation signal output units 13 whose number is N which is the same as the number of series cancellation signal injection units 14, are provided.

The abnormality detection signal AS from the abnormality detection unit 17 of the cancellation signal output unit 13 connected to the cancellation signal injection unit 14Al on the one electric path 11A of the electric paths arranged in parallel is also inputted to the cancellation signal injection unit 14B1. The abnormality detection signal AS from the abnormality detection unit 17 of the cancellation signal output unit 13 connected to the cancellation signal injection unit 14B1 on the other electric path 11B of the electric paths arranged in parallel is also inputted to the cancellation signal injection unit 14Al. Hereinafter, the same configuration applies throughout arrangement up to combination of the cancellation signal injection unit 14AN and the cancellation signal injection unit 14BN.

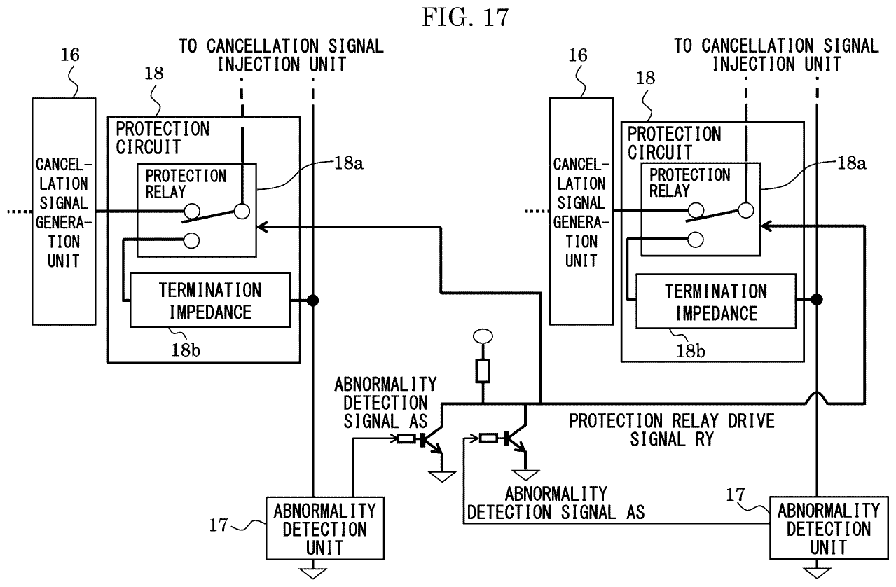

FIG. 17 shows an example of a configuration for transfer of the abnormality detection signal AS between the cancellation signal output units 13 in the noise filter 100a shown in FIG. 15 and the noise filter 100b shown in FIG. 16. The abnormality detection signals AS outputted from the abnormality detection units 17 are inputted to a transistor circuit connected by wired OR connection via a base resistor, for example, and thus are unified as one protection relay drive signal RY, to switch the protection relays 18a of the two cancellation signal output units simultaneously.

### Effects of Embodiment 2

As described above, the noise filter according to embodiment 2 is configured with a plurality of divided cancellation signal injection units, thus providing an effect of achieving high reliability even in a case where the noise filter is provided between a load and a power conversion device having a large capacity.

More specifically, even in protection operation, the numbers of the cancellation signal injection units 14 are kept the same between the electric path 11A and the electric path 11B, whereby it is possible to suppress occurrence of compensation voltage difference between the one electric path 11A and the other electric path 11B arranged in parallel, and occurrence of great circulation current due to compensation voltage difference.

Therefore, while suppressing occurrence of circulation current due to compensation voltage difference between parallel arrangements, it is possible to effectively prevent increase in common mode noise due to unintentional resonance by change in the resonant frequency of the common mode path or occurrence of magnetic saturation due to unintentional increase in the interposition impedance of the injection transformer 14g, as in embodiment 1, thus providing an effect of achieving the noise filter having high reliability even in a case where the noise filter is provided between a load and a power conversion device having a large capacity.

### Embodiment 3

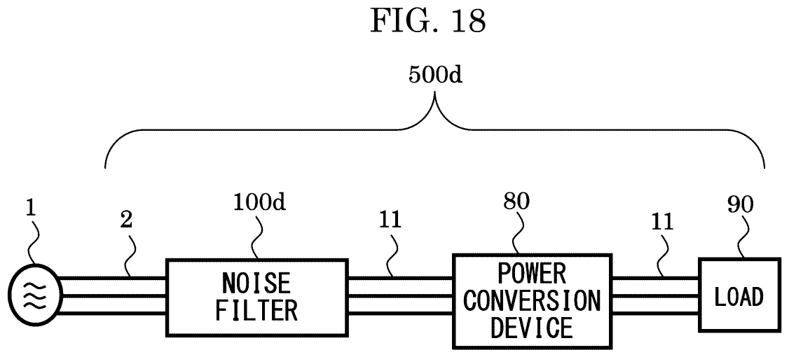

A noise filter 100d and a power conversion system 500d according to embodiment 3 will be described with reference to FIG. 18 to FIG. 26.

FIG. 18 is an entire configuration diagram showing the power conversion system 500d according to embodiment 3.

The power conversion system 500d includes the power conversion device 80 which is provided between the AC power supply 1 and the load 90 and converts input power from the AC power supply 1 to desired DC power or AC power, and the noise filter 100d interposed between the AC power supply 1 and the power conversion device 80. The AC power supply 1 and the noise filter 100d are connected via the electric path 2, and the noise filter 100d, the power conversion device 80, and the load 90 are connected via the electric path 11.

The electric path 11 is connected to the electric path 2 of the AC power supply 1, and input power from the AC power supply 1 is inputted to the power conversion device 80 via the electric path 2. The power conversion device 80 converts power inputted from the AC power supply 1 to power needed for driving the load 90, and outputs the converted power. Although the noise filter 100d is provided between the AC power supply 1 and the power conversion device 80 in embodiment 3, the noise filter 100d may be provided between the power conversion device 80 and the load 90.

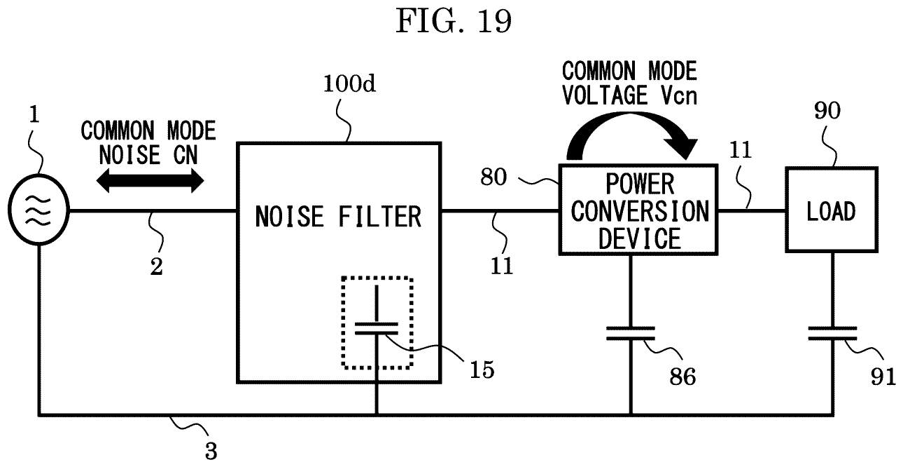

FIG. 19 illustrates common mode noise CN occurring in the power conversion system 500d according to embodiment 3, and shows a common. mode equivalent circuit. In the power conversion system 500d, the AC power supply 1 and the load 90 are connected on the ground side via the ground line 3, as well as the electric path 11 described above. The noise filter 100d is provided with the ground capacitor 15 having one end connected to the ground line 3. In addition, the parasitic capacitance 86 is present between the power conversion device 80 and the ground line 3, and the parasitic capacitance 91 is present between the load 90 and the ground line 3. In the power conversion system 500d, the common mode voltage Von of the power conversion device 80 is applied to the common mode loop passing through the parasitic capacitances 86, 91 and the ground line 3, and common mode current (common mode noise CN) flows as shown by an arrow in FIG. 19.

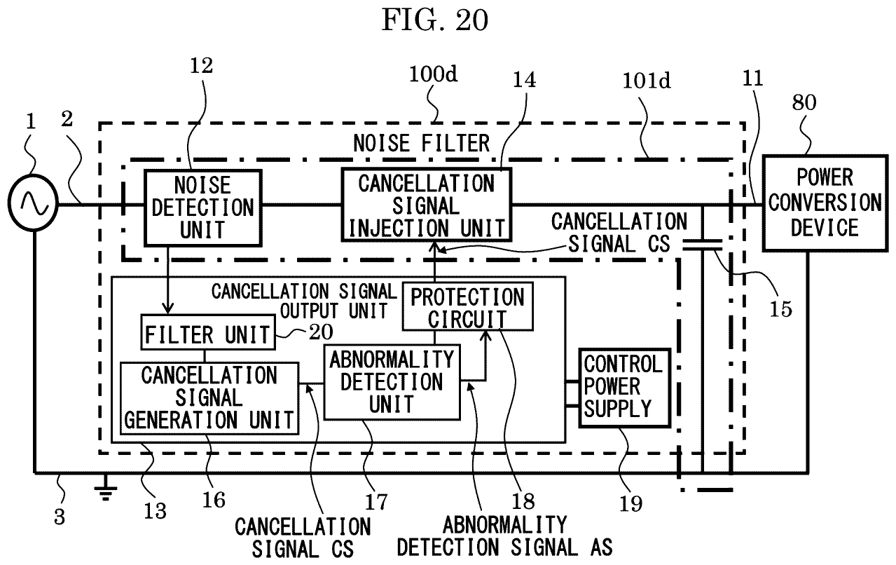

FIG. 20 is a configuration diagram showing the noise filter 100d according to embodiment 3. The noise filter 100d is interposed between the AC power supply 1 and the power conversion device 80. The noise filter 100d includes the noise detection unit 12 provided on the electric path 11 connected to the electric path 2, the cancellation signal output unit 13 which generates the cancellation signal CS from the common mode noise CN (not shown in FIG. 20) detected by the noise detection unit 12 and outputs the cancellation signal CS, the cancellation signal injection unit 14 which is provided on the electric path 11 on the output end side, i. e., on the power conversion device 80 side, relative to the noise detection unit 12, and injects the cancellation signal CS outputted from the cancellation signal output unit 13 into the electric path 11, the control power supply 19 which supplies the cancellation signal output unit 13 with power for generating and injecting the cancellation signal CS, and the protection circuit 18 which is interposed between the control power supply 19 and the cancellation signal output unit 13 and can interrupt supply of power from the control power supply 19.

In the noise filter 100d according to embodiment 3, the protection circuit 18 which can interrupt connection between the cancellation signal output unit 13 and the cancellation signal injection unit 14 is provided as protection means for preventing an abnormal cancellation signal CS from being injected into the electric path 11.

Unlike the noise filters according to embodiments 1 and 2, the noise filter 100d according to embodiment 3 forms a feedback control system. The feedback control system has an advantage in being robust against impedance error of a control target, as compared to feedforward. In the noise filter 100d, the ground capacitor 15 connected between the electric path 11 and the ground line 3 is provided, and the noise detection unit 12, the cancellation signal injection unit 14, and the ground capacitor 15 form a main circuit section 101d in the power conversion system 500d. In addition, a filter unit 20 is provided between the noise detection unit 12 and the cancellation signal generation unit 16. The filter unit 20 adjusts a characteristic of the cancellation signal CS through adjustment of the noise detection signal DS.

The control characteristic of the noise filter 100d greatly depends on the main circuit section 101d. An inductance value of the main circuit section 101d is the sum of an inductance value of the common mode transformer forming the noise detection unit 12 and an inductance value of the injection transformer 14g forming the cancellation signal injection unit 14. A capacitance value of the main circuit section 101d is a capacitance value of the ground capacitor 15. The details of the control characteristic of the main circuit section 101d will be described later.

A problem in a case where the noise filter 100d forms the feedback control system will be described below.

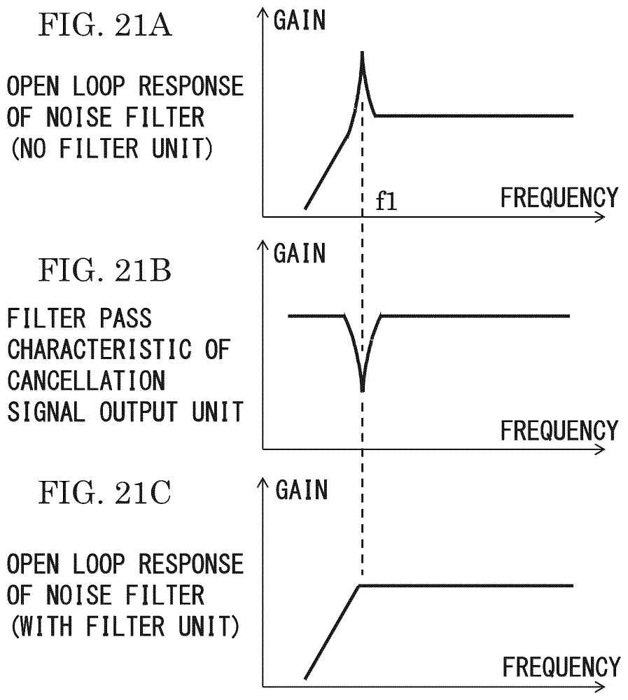

First, control response of the main circuit section 101d of the noise filter 100d will be described. FIG. 21A, FIG. 21B, and FIG. 21C show control response of the main circuit section 101d of the noise filter 100d according to embodiment 3. FIG. 21A shows control response in a case of not having the filter unit 20, FIG. 21B shows a pass characteristic of the filter unit 20, and FIG. 21C shows control response in a case of having the filter unit 20. In FIG. 21A, FIG. 21B, and FIG. 21C, the horizontal axes indicate frequency and the vertical axes indicate gain.

Here, control response refers to open loop response on a path starting from the output of the noise detection unit 12, passing through the cancellation signal output unit 13 and the cancellation signal injection unit 14, and then returning to the noise detection unit 12. Control stability of the noise filter 100d depends on the values of a gain margin and a phase margin of the open loop response.

As shown in FIG. 21A, in open loop response of the noise filter in the case of not having the filter unit 20, a great resonance peak arises and the gain sharply increases, at a resonant frequency f1 of the main circuit section 101d. In addition, phase rotation also occurs at the resonant frequency f1, although not shown in FIG. 21A. Thus, in the case of not having the filter unit 20, control response of the noise filter becomes unstable at the resonant frequency f. In a case where a component at the resonant frequency f1 is contained in the common mode noise CN detected by the noise detection unit 12, there is a possibility that the cancellation signal CS also becomes unstable. The resonant frequency f1 is represented as f1=1/{2π√(L1×C1)}. Here, L1 is an inductance value of the main circuit section 101d, and C1 is a capacitance value of the main circuit section 101d.

As described above, in the case of not having the filter unit 20, control response of the noise filter 100d becomes unstable at the resonant frequency f1. As a measure therefor, the filter unit 20 having the filter pass characteristic shown in FIG. 21B is provided between the noise detection unit 12 and the cancellation signal generation unit 16. The filter unit 20 is configured such that the rejection frequency thereof coincides with the resonant frequency f1 of the main circuit section 101d. Such a filter unit 20 can be realized by a notch filter, for example. By configuring the filter unit 20 as described above, a filter pass characteristic in which the gain is greatly reduced at the resonant frequency f1 is obtained as shown in FIG. 21B. Thus, in open loop response of the noise filter 100d in the case of having the filter unit 20, as shown in FIG. 21C, the great resonance peak at the resonant frequency f1 is attenuated by the filter pass characteristic of the filter unit 20.

As described above, in the case of providing the filter unit 20 between the noise detection unit 12 and the cancellation signal generation unit 16, it is possible to generate the cancellation signal CS with the resonance peak attenuated, even if a component at the resonant frequency f1 is contained in the common mode noise CN detected by the noise detection unit 12. As a result, the noise filter 100d can exert a noise suppression effect stably.

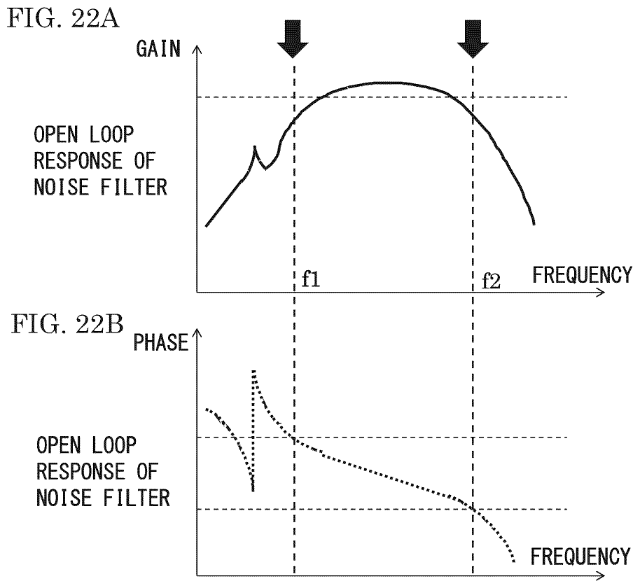

FIG. 22A and FIG. 22B show control response of the noise filter 100d according to embodiment 3. FIG. 22A shows a gain characteristic and FIG. 22B shows a phase characteristic. In the characteristic (control characteristic) of control response of the noise filter 100d, the phase rotates due to phase lags in the main circuit section 101d, the cancellation signal generation unit 16, and the filter unit 20.

In the examples shown in FIG. 22A and FIG. 22B, as the filter unit 20 of the noise filter 100d, a notch filter and a low-pass filter (both are not shown in the drawings) are combined so that the resonance peak at the resonant frequency f1 as described above is suppressed and a gain margin G2 at a phase inversion frequency f2 in a low-frequency band and a gain margin G3 at a phase inversion frequency f3 in a high-frequency band are each set at a value that can ensure control stability. Here, the gain margins G2 and G3 are indicated by upward arrows when they have positive values, and indicated by downward arrows when they have negative values. The value that can ensure control stability is, for example, 6 dB.

Regarding the noise filter 100d in which the resonance peak is attenuated and the gain margins G2 and G3 at the phase inversion frequency are each set at a value that can ensure control stability as in the examples shown in FIG. 22A and FIG. 22B, a situation in which the control characteristic of the noise filter 100d changes due to occurrence of some abnormality will be described below.

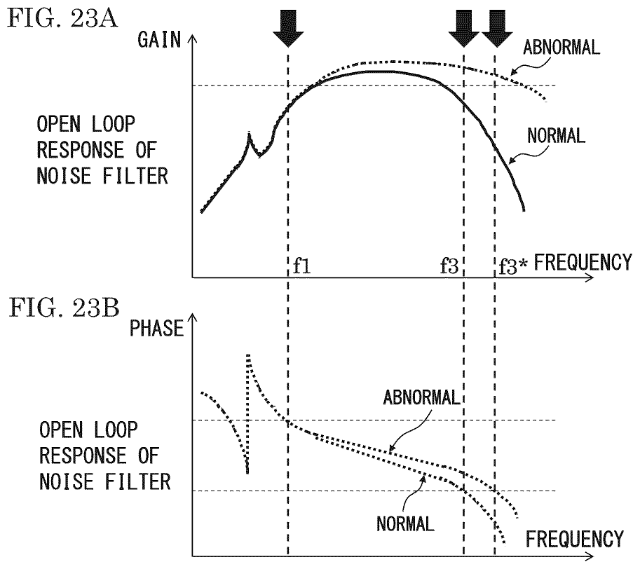

FIG. 23A and FIG. 23B show control response in a case where the control characteristic has changed due to occurrence of abnormality in the noise filter 100d according to embodiment 3. FIG. 23A shows change in the gain characteristic and FIG. 23B shows change in the phase characteristic. For comparison between a normal case and an abnormal case, the gain characteristic and the phase characteristic in a normal case are indicated by solid lines, and the gain characteristic and the phase characteristic in an abnormal case are indicated by broken lines. Here, as “abnormality”, it is assumed that the phase inversion frequency f3 in the high-frequency band has changed to a frequency f3*.

A typical example of such abnormality is a case where the function of the low-pass filter is lost due to component failure or the like and the characteristic of the filter unit has changed accordingly. In such a case, the value of the gain margin G3 at the phase inversion frequency f3 in the high-frequency band might change so as to deviate from the value that can ensure control stability.

As shown in FIG. 23A, the gain margin at the phase inversion frequency f3 in the high-frequency band has changed to a gain margin G3* having a negative value. Thus, it is found that control response of the noise filter 100d has become unstable. When control response is unstable, the cancellation signal CS outputted from the cancellation signal output unit 13 also becomes an unstable signal having an abnormal output waveform, so that the abnormal and unstable cancellation signal CS is injected into the electric path 11.

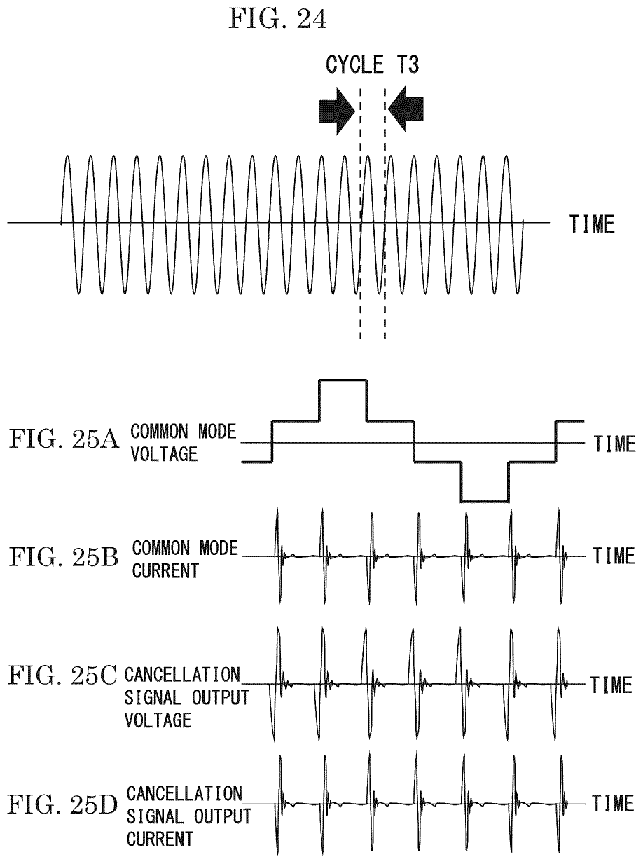

FIG. 24 shows an abnormal output waveform of the cancellation signal output unit 13 according to embodiment 3, and shows an example of the waveform of the cancellation signal CS in an abnormal case. In FIG. 24, the horizontal axis indicates time. Since the gain margin at the phase inversion frequency f3 has become a negative value, as shown in FIG. 24, the frequency component at the phase inversion frequency f3 continues to be amplified, thus causing oscillation. A section between broken lines indicated by arrows in FIG. 24 indicates a cycle T3 of the cancellation signal CS in an abnormal case. The cycle T3 is equal to the reciprocal of the phase inversion frequency f3.

When the cancellation signal CS has caused oscillation, a noise source for the common mode noise CN is produced also at the noise filter 100d in the common mode equivalent circuit shown in FIG. 19. In the common mode equivalent circuit, noise source voltage is allocated to the load 90, a grid, and the power conversion device 80 in accordance with their respective impedance ratios.

On the grid side, the noise filter 100d does not operate normally and thus a normal attenuation amount is not obtained, and in addition, conduction noise due to oscillation operation of the noise filter 100d flows out to the grid via the electric path 11. On the load 90 side, for example, shaft voltage of a motor might increase. In the power conversion device 80, erroneous operation might be caused by the common mode noise CN generated by itself.

As described above, in a case of using an active noise filter forming a feedback control system, such as the noise filter 100d according to embodiment 3, it is not desirable that abnormal output operation such as control oscillation which can be caused by characteristic change due to component failure or the like is left.

As described above, the cancellation signal injection unit 14 of the noise filter 100d according to embodiment 3 is formed by the injection transformer 14g. The injection transformer 14g forming the cancellation signal injection unit 14 serves as an inductance load having an inductive impedance for the cancellation signal output unit 13, and thus has a high impedance in a high-frequency band.

Therefore, even in a state in which the cancellation signal output unit 13 continues performing abnormal high-frequency oscillation operation as shown in FIG. 24 and the noise filter cannot normally perform noise suppression operation, a phenomenon such as overvoltage or overcurrent that influences the standards of circuit components does not immediately occur in the cancellation signal output unit 13. That is, as long as abnormality of the noise filter cannot be detected, the noise filter is not stopped by a protection function even if an overvoltage protection circuit or an overcurrent protection circuit is provided to the noise filter.

In this regard, in the noise filter 100d according to embodiment 3, abnormality detection is performed by the abnormality detection unit 17, and if abnormality is detected, the protection circuit 18 is operated to stop injection of the cancellation signal CS and connect the termination impedance 18b to the cancellation signal injection unit 14, whereby the problem in the case of constructing the feedback control system can also be solved at the same time. Hereinafter, this will be described specifically while comparing the cancellation signal CS in a normal case and the cancellation signal CS in an abnormal case.

FIG. 25A shows the waveform of common mode voltage in a normal case, and FIG. 25B shows the waveform of common mode current in a normal case. FIG. 25C shows the waveform of output voltage of the cancellation signal CS in a normal case in the noise filter 100d according to embodiment 3, and FIG. 25D shows the waveform of output current of the cancellation signal CS in a normal case. In FIG. 25A to FIG. 25D, the horizontal axes indicate time.

In FIG. 25A, the common mode voltage is voltage of the common mode noise CN. In FIG. 25B, the common mode current is current flowing through the electric path 11 by the common mode voltage. That is, the common mode current is current flowing through the electric path 11 when the common mode voltage is inputted to the common mode equivalent circuit shown in FIG. 19 and under the assumption that the noise filter 100d is absent.

The common mode voltage arises due to switching operation of each semiconductor switch composing the power conversion device 80 shown in FIG. 2 and has a rectangular waveform as shown in FIG. 25A. The common mode current has a spike-shaped waveform as shown in FIG. 25B and causes a noise problem at various locations on the path.

The noise detection unit 12 of the noise filter 100d detects the common mode current and transmits the noise detection signal DS to the cancellation signal output unit 13, and the cancellation signal output unit 13 generates the cancellation signal CS from the noise detection signal DS. The cancellation signal CS is injected into the electric path 11 via the cancellation signal injection unit 14.

Output voltage of the cancellation signal CS in a normal case has a spike-shaped waveform as shown in FIG. 25C. In addition, output current of the cancellation signal CS produced by the output voltage of the cancellation signal CS also has a spike-shaped waveform as shown in FIG. 25D. The output current of the cancellation signal CS is current that cancels out the common mode current, and therefore has feature that the output current has a waveform in which the effective value is extremely smaller than the peak value as in the common mode current.

In actuality, noise current flowing out from the power conversion device 80 which is a noise source for the common mode noise CN passes through the cancellation signal injection unit 14, so that a disturbance component is superimposed on the output current of the cancellation signal CS, and in addition, a disturbance component is also superimposed on the output voltage of the cancellation signal CS, as a product of current and an output impedance of the cancellation signal CS. However, for facilitating the understanding of the gist of the present disclosure, superimpositions of disturbance components as described above are ignored in FIG. 25C and FIG. 25D.

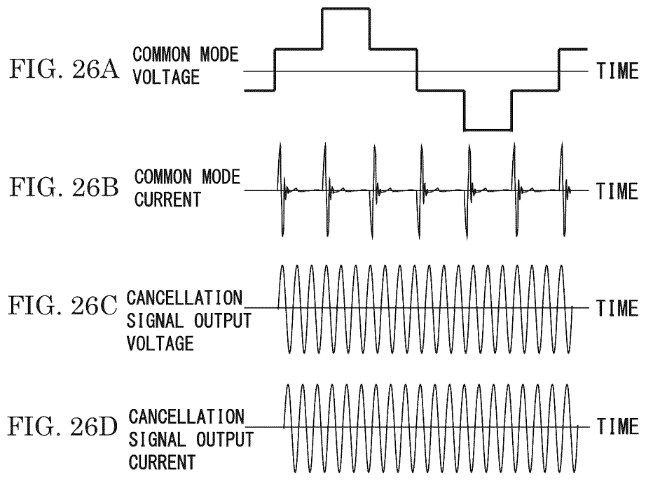

FIG. 26A shows the waveform of common mode voltage in an abnormal case, and FIG. 26B shows the waveform of common mode current in an abnormal case. FIG. 260 shows the waveform of output voltage of the cancellation signal CS in an abnormal case in the noise filter 100d according to embodiment 3, and FIG. 26D shows the waveform of output current of the cancellation signal CS in an abnormal case. In FIG. 26A to FIG. 26D, the horizontal axes indicate time.

As shown in FIG. 26A and FIG. 26B, the common mode voltage and the common mode current do not change even in an abnormal case. Meanwhile, in an abnormal case, the noise filter 100d has undergone change in the control characteristic, so that the cancellation signal CS causes oscillation. Thus, as shown in FIG. 26C and FIG. 26D, the waveforms of output voltage and output current of the cancellation signal CS become abnormal output waveforms as shown in FIG. 24.

The abnormal output waveforms do not have such a feature that the waveforms in a normal case have, i.e., a feature that the effective value is extremely smaller than the peak value. Specifically, in the waveforms in an abnormal case shown in FIG. 260 and FIG. 26D, the voltage effective value of output voltage of the cancellation signal CS becomes 1/√2 times the voltage peak value, and thus there is not a great difference between the peak value and the effective value.

In addition, the current effective value of output current of the cancellation signal CS becomes 1/√2 times the current peak value, and thus there is not a great difference between the peak value and the effective value. The same applies also in a case where output voltage of the operational amplifier is saturated due to oscillation operation at a high gain and the waveform of output voltage of the cancellation signal CS becomes a rectangular waveform.

As described above, in an abnormal case, it is found that the voltage effective value of output voltage and the current effective value of output current of the cancellation signal CS become greater than in a normal case. That is, in an abnormal case, the voltage effective value of output voltage of the cancellation signal CS can be used as a determination criterion for abnormality. With the determination criterion applied, by providing appropriate threshold voltage or threshold current and comparing the actual voltage effective value and the threshold voltage or the actual current effective value and the threshold current, it is possible to determine whether the noise filter 100d is normally operating, i.e., the noise filter 100d is successfully canceling out the common mode current, or the noise filter 100d has fallen into abnormal operation for some reason.

Typically, where the voltage effective value of output voltage of the cancellation signal CS in a normal case is denoted by VI, the threshold voltage for the voltage effective value for determining whether or not there is abnormality is denoted by Vth, and the voltage effective value in a case of abnormal operation is denoted by V2, the threshold voltage Vth for the voltage effective value may be selected so as to satisfy V1<Vth <V2, whereby it is possible to determine whether or not there is abnormality.

The same applies to a case of using the current effective value of output current of the cancellation signal CS for determination as to whether or not there is abnormality.

### Effects of Embodiment 3

As described above, the noise filter according to embodiment 3 provides an effect of achieving high reliability even in a case where the noise filter forms a feedback control system.

More specifically, in a case where abnormality has occurred so that the noise filter needs to be protected, abnormality is detected from change in output voltage or output current of the cancellation signal CS due to the abnormality, output of the noise cancellation signal from the cancellation signal output unit to the cancellation signal injection unit is restricted, and the abnormal cancellation signal is prevented from being injected into the electric path. In addition, the termination impedance is connected to the auxiliary winding of the injection transformer forming the cancellation signal injection unit, whereby increase in common mode noise CN due to unintentional resonance by change in the resonant frequency of the common mode path or occurrence of magnetic saturation due to unintentional increase in the interposition impedance of the injection transformer is prevented. Thus, an effect of achieving high reliability is provided.

In addition, abnormality of the noise filter is detected on the basis of output voltage or output current of the cancellation signal CS, thus providing an effect that abnormality of the noise filter in a high-frequency band can be assuredly detected even if the cancellation signal injection unit for the cancellation signal CS is formed by an inductance load such as a common mode transformer (injection transformer).

Further, since generation and injection of the cancellation signal CS are stopped by the protection circuit when abnormality is detected, stable operation can be performed while the gain margin and the phase margin for suppressing control oscillation in the feedback control system can be set at lower values than in conventional art.

That the gain margin and the phase margin can be set at lower values than in conventional art means that the control gain of the noise filter is improved, and thus an effect that the noise suppression amount can be improved is provided.

### Embodiment 4

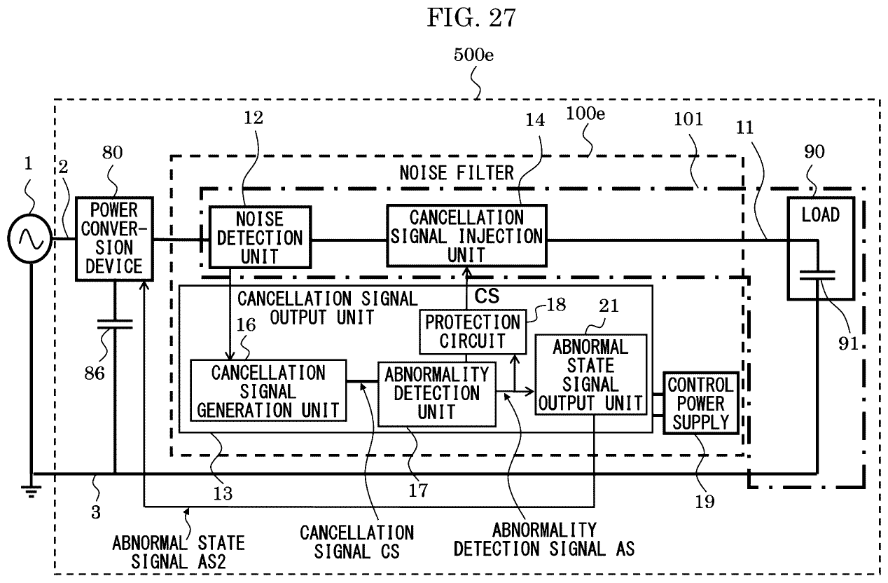

A noise filter 100e and a power conversion system 500e according to embodiment 4 will be described with reference to FIG. 27. Parts that are the same as or correspond to those in FIG. 1 to FIG. 26 are denoted by the same reference characters, and the description thereof is omitted. FIG. 27 is a configuration diagram showing the noise filter 100e and the power conversion system 500e according to embodiment 4. The noise filters according to embodiments 1, 2, and 3 each include the protection circuit 18 which performs operation of interrupting connection between the cancellation signal injection unit 14 and the cancellation signal output unit by the abnormality detection signal AS, and connecting the cancellation signal injection unit 14 and the termination impedance 18b.

On the other hand, the noise filter 100e according to embodiment 4 has a function of notifying the power conversion device 80 which is a noise source about abnormality of the noise filter 100e, instead of the protection circuit 18 described above. Therefore, in the noise filter 100e according to embodiment 4, the protection circuit 18 is not an essential component. The noise filter 100e has an abnormal state signal output unit 21 in the cancellation signal output unit 13, and the abnormality detection signal AS outputted from the abnormality detection unit 17 is inputted to the abnormal state signal output unit 21. In the noise filter 100e according to embodiment 4, the abnormal state signal output unit 21 is provided as protection means for preventing an abnormal cancellation signal CS from being injected into the electric path 11.

The abnormal state signal output unit 21 has an output circuit that can output a signal to the power conversion device 80, and outputs an abnormal state signal AS2 to the power conversion device 80 when the abnormality detection signal AS is inputted. Typically, the abnormal state signal AS2 is a differential signal robust to disturbance, a current signal for a low impedance, or the like, and is generated on the basis of the abnormality detection signal AS. In addition, the abnormal state signal AS2 is isolated from a control potential of the noise filter 100e, as necessary. The power conversion device 80 that has received the abnormal state signal AS2 recognizes that the noise filter 100e is in an abnormal state.

The power conversion device 80 that has recognized that the noise filter 100e is in an abnormal state performs processing such as stopping operation, in accordance with the details of the abnormality, using a prediction calculation unit (not shown), for example. A control circuit for stopping the power conversion device 80 on the basis of the abnormal state signal AS2 may be provided outside or inside the power conversion device 80. The control circuit receives the abnormal state signal AS2 and transmits a stop instruction to the power conversion device 80 as necessary.

### Effects of Embodiment 4

As described above, the noise filter according to embodiment 4 is provided with the abnormal state signal output unit, thus providing an effect of obtaining the noise filter having high reliability.

Unlike embodiments 1, 2, and 3, the noise filter according to embodiment 4 does not directly cope with problems such as change in the common mode resonant frequency and core magnetic saturation of the injection transformer 14g due to change in the interposition impedance of the injection transformer 14g in protection operation. However, by the abnormal state signal, the power conversion device which is a noise source for the common mode noise CN is made to recognize abnormality of the noise filter. In this case, the power conversion device performs processing such as stopping operation as necessary, and thus, since the noise source for the common mode noise CN is stopped, an effect of preventing such a phenomenon that an abnormal cancellation signal is generated and injected into the electric path or the common mode noise CN is increased by an unintentional common mode resonant frequency, is provided.

As described above, in the noise filter according to embodiment 4, the power conversion device 80 which is a noise source is made to recognize abnormality of the noise filter, whereby injection of an abnormal cancellation signal CS into the electric path or unintentional increase in the common mode noise CN are indirectly prevented, thus providing an effect of achieving high reliability of the noise filter.

The noise filter 100e according to embodiment 4 may be combined with the protection circuit 18 of the noise filter according to each of embodiments 1, 2, and 3. In addition, since the noise filter 100e according to embodiment 4 outputs the abnormal state signal AS2 to the noise source for the common mode noise CN, if there is another controlled device that is a noise source for the common mode noise CN, the abnormal state signal AS2 may be outputted also to the other controlled device.

### Embodiment 5

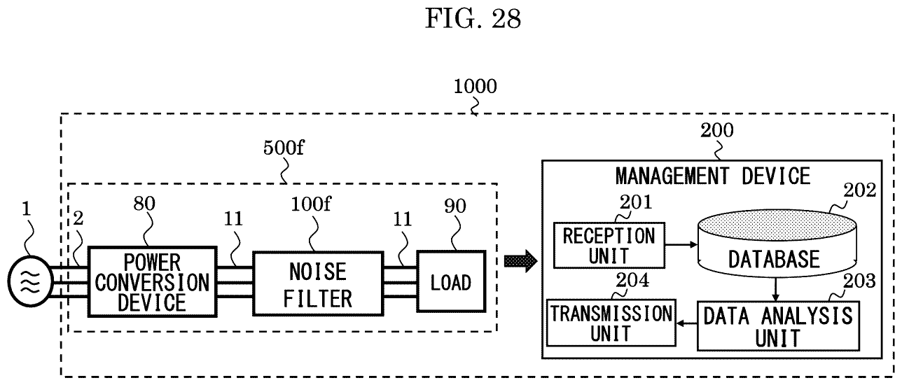

FIG. 28 is a configuration diagram showing a management system 1000 according to embodiment 5. The management system 1000 is composed of a power conversion system 500f and a management device 200.

The power conversion system 500f includes the power conversion device 80 which is provided between the AC power supply 1 and the load 90 and converts input power from the AC power supply 1 to desired DC power or AC power, the load 90 which is supplied with the desired DC power or AC power from the power conversion device 80, and a noise filter 100f which is provided on the electric path 11 connecting the power conversion device 80 and the load 90 and has a communication function. The noise filter 100f may be provided on the electric path 2 connecting the AC power supply 1 and the power conversion device 80. As described above, a DC power supply may be used instead of the AC power supply 1.

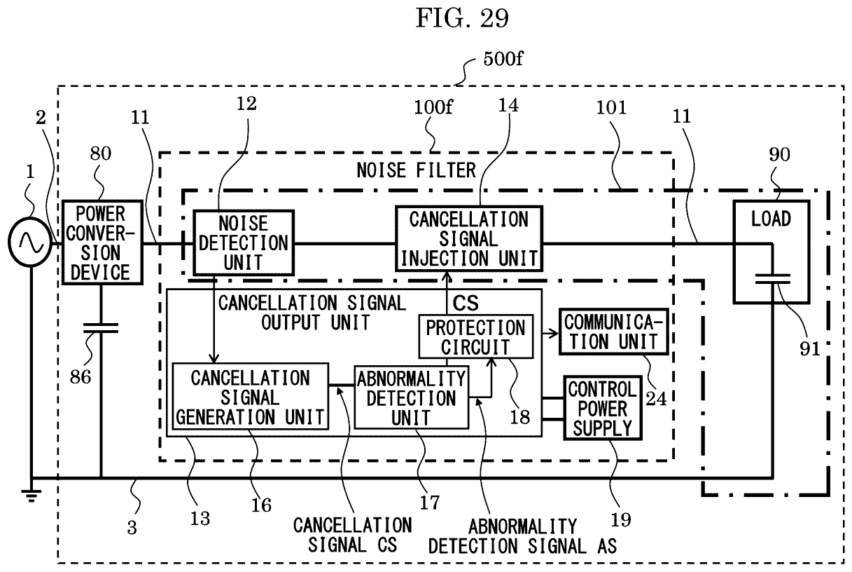

FIG. 29 is a configuration diagram showing the noise filter 100f having a communication function and applied to the power conversion system 500f according to embodiment 5. The configuration of the power conversion system 500f according to embodiment 5 is different from the configuration of the noise filter 100 according to embodiment 1 in that the noise filter 100f includes a communication unit 24 connected to the cancellation signal output unit 13.

The communication unit 24 which is a part of the configuration of the noise filter 100f converts various signals such as the cancellation signal CS and the abnormality detection signal AS generated inside the cancellation signal output unit 13, to data, and transmits the data to the outside of the power conversion system 500f. The transmission may be performed via the Internet.

The management device 200 composing the management system 1000 includes a reception unit 201, a database 202, a data analysis unit 203, and a transmission unit 204, as shown in FIG. 28.

The reception unit 201 receives data transmitted to the outside of the power conversion system 500f, via the communication unit 24 of the noise filter 100f, and stores the data in the database 202. It is also possible that the reception unit 201 receives data transmitted from the power conversion systems 500f that a plurality of clients have, at the same time.

In the database 202, data transmitted from the power conversion system 500f is sequentially stored. Data transmitted individually from a plurality of power conversion systems 500f of different clients may be stored separately in areas designated for the respective clients in the database 202.

The data analysis unit 203 performs various types of analysis for the tendency, the occurrence frequency, the Causes, and the like of abnormalities that have occurred in the power conversion system 500f, on the basis of the data accumulated in the database 202. As an example of analysis, if the power conversion device 80 has failed frequently, each component thereof may be diagnosed and recommended to be replaced.

The transmission unit 204 transmits an analysis result from the data analysis unit 203 to the outside of the management system 1000 via, for example, the Internet. The transmission destination is, for example, a management system of a client who operates the power conversion system 500f.

In the noise filter 100f composing the power conversion system 500f, as described above, in a case where abnormality is detected, the abnormality detection unit 17 transmits the abnormality detection signal AS, and the protection circuit 18 operates to perform protection operation of interrupting connection between the cancellation signal generation unit 16 and the cancellation signal injection unit 14, thus achieving high reliability of the power conversion system 500f.

However, in such a situation that the above protection operation is frequently performed, it is necessary to find out a cause for abnormality and take a measure for the cause, and this is important for improvement in reliability of the power conversion system. When the management system 1000 according to embodiment 5 is applied, the data analysis unit 203 analyzes data transmitted from the power conversion system 500f to the management device 200, whereby, for example, a cause for abnormality is figured out and a coping method for solving the abnormality is proposed. Thus, it becomes possible to eliminate the cause for the abnormality at an early stage, leading to further improvement in reliability of the power conversion system 500f.

In addition, by using the management system 1000 according to embodiment 5, it becomes possible to recognize the operation state of the power conversion system 500f remotely, so that management and maintenance for the power conversion system 500f are facilitated. Further, a client who operates the power conversion system 500f can easily acquire an analysis result and a coping method for abnormality from the management device 200 via, for example, the Internet, and thus can execute maintenance, inspection, and the like for the power conversion system 500f at appropriate times, or can decrease the number of times of maintenance, inspection, and the like, whereby labor saving can be achieved at the same time.

### Effects of Embodiment 5

As described above, the management system 1000 according to embodiment 5 has the management device 200 which performs data analysis using data transmitted from the power conversion system 500f, whereby it becomes possible to swiftly cope with a cause for abnormality, thus providing an effect of further improving reliability of the power conversion system 500 and also providing an effect of improving ease of management and maintenance for the power conversion system.

### Embodiment 6

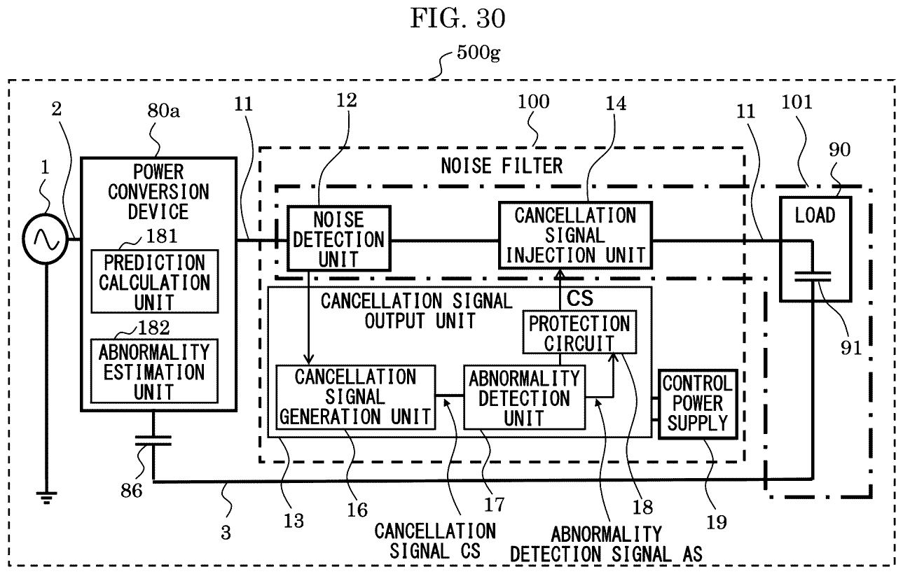

A power conversion system 500g according to embodiment 6 will be described with reference to FIG. 30.

FIG. 30 is a configuration diagram showing the power conversion system 500g according to embodiment 6. The power conversion system 500g according to embodiment 6 is different from the power conversion system 500 according to embodiment 1 in that a power conversion device 80a includes a prediction calculation unit 181 and an abnormality estimation unit 182. The configuration of the noise filter 100 is the same as that in embodiment 1.

In a case where the noise filter 100 has fallen into an abnormal state, i.e., in a state in which the abnormality detection unit 17 of the noise filter 100 transmits the abnormality detection signal AS, the prediction calculation unit 181 of the power conversion device 80a recognizes that the noise filter 100 is in an abnormal state, and outputs a resonant frequency prediction value on the basis of the abnormality detection signal AS. The prediction calculation unit 181 can also execute a measure of changing the switching frequency on the basis of the resonant frequency prediction value.

In a case where the abnormality detection signal AS has continued for not less than a predetermined period, the abnormality estimation unit 182 of the power conversion device 80a outputs an abnormality continuation determination value. Further, it is also possible to stop operation of the power conversion device 80a on the basis of the abnormality continuation determination value.

### Effects of Embodiment 6

As described above, the power conversion system according to embodiment 6 has the prediction calculation unit and the abnormality estimation unit inside the power conversion device, whereby it becomes possible to cope with an abnormal state also on the power conversion device side, thus providing an effect of obtaining a power conversion system having high reliability.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure.

For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 AC power supply
2, 11, 11A, 11B electric path
3 ground line
b 12 noise detection unit
12a, 12b, 12c, 12e detection capacitor
12d T-phase winding
12f star connection point
12n detection capacitor network
13 cancellation signal output unit
14, 14A1, 14A2, 14A3, 14B1, 14B2, 14B3 cancellation signal injection unit
14a R-phase winding
14b S-phase winding
14c T-phase winding
14d injection winding
14g injection transformer
15 ground capacitor
16 cancellation signal generation unit
16a input resistor
16b operational amplifier
16c feedback resistor
17 abnormality detection unit
18 protection circuit
18a protection relay
18b termination impedance
19 control power supply
20 filter unit
21 abnormal state signal output unit
24 communication unit
71 processor
72 memory
73 auxiliary storage device
74 interface
80, 80a power conversion device
81 DC power supply
82, 83, 84 upper-lower arm
82a, 82b, 83a, 83b, 84a, 84b semiconductor switch
85 inverter output terminal
86, 91 parasitic capacitance
90 load
100, 100a, 100b, 100d, 100e, 100f noise filter
101, 101d main circuit section
171 feature quantity detection unit
171a, 171b operational amplifier
171c, 171d, 171e, 171h, 171i, 171j, 171m, 171l resistor
171f, 171g diode
171k Capacitor
172 feature quantity comparison unit
172a comparator
172b DC voltage source
172c pull-up resistor
181 prediction calculation unit
182 abnormality estimation unit
200 management device
201 reception unit
202 database
203 data analysis unit
204 transmission unit
500, 500d, 500e, 500f, 500g power conversion system
1000 management system
AS abnormality detection signal
AS2 abnormal state signal
CN common mode noise
CS cancellation signal
CV feature quantity signal
DS noise detection signal

1. A noise filter provided on one of an electric path connecting an AC or DC power supply and a power conversion device which converts power outputted from the AC or DC power supply to AC or DC power, or an electric path connecting the power conversion device and a load, the noise filter comprising at least one processor configured to implement:
a noise detector which detects common mode noise occurring during operation of the power conversion device;
a cancellation signal generator which generates a cancellation signal for canceling out the common mode noise;
a cancellation signal injection circuitry which injects the cancellation signal into the electric path;
an abnormality detector which outputs an abnormality detection signal in a case where it is detected that the cancellation signal is abnormal; and
a protection circuit which controls injection of the cancellation signal into the electric path on the basis of the abnormality detection signal, and has a protection relay and a termination impedance having one end connected to the protection relay, wherein
an abnormality processing sequence is executed on the basis of the abnormality detection signal.

2.-3. (canceled)

4. The noise filter according to claim 1, wherein
the termination impedance is set at such an impedance value that prevents magnetic saturation of an injection transformer forming the cancellation signal injection circuitry when the protection circuit operates.

5. The noise filter according to claim 1, wherein
in a case where output voltage of the cancellation signal is higher than predetermined threshold voltage or output current of the cancellation signal is higher than predetermined threshold current, the abnormality detector determines that the cancellation signal is abnormal, and outputs the abnormality detection signal.

6. The noise filter according to claim 1, wherein
the abnormality processing sequence is a sequence in which the protection circuit is operated on the basis of the abnormality detection signal, to interrupt injection of the cancellation signal into the electric path and connect both ends of the cancellation signal injection circuitry to the termination impedance.

7. The noise filter according to claim 1, wherein
the abnormality processing sequence is a sequence in which, on the basis of the abnormality detection signal, the power conversion device performs determination for abnormality, and on the basis of a resonant frequency predicted in a prediction calculation calculator that the power conversion device has, a switching frequency is changed.

8. The noise filter according to claim 1, wherein
the abnormality processing sequence is a sequence in which, on the basis of the abnormality detection signal, the power conversion device performs determination for abnormality, and the power conversion device is stopped.

9. The noise filter according to claim 1, wherein
a plurality of the cancellation signal injection circuitries are provided, and
the plurality of cancellation signal injection circuitries are arranged in series or parallel on the electric path.

10. The noise filter according to claim 1, wherein
a plurality of the cancellation signal injection circuitries are provided, the plurality of cancellation signal injection circuitries arranged in series are arranged in parallel on the electric path, and numbers of the plurality of cancellation signal injection circuitries are the same between parallel arrangements.

11. The noise filter according to claim 1, wherein
the noise filter is provided on the electric path on an output side of the power conversion device.

12. The noise filter according to claim 1, wherein
the noise filter is provided on the electric path on an input side of the power conversion device.

13. The noise filter according to claim 11, wherein
a filter circuitry is provided between the noise detection unit detector and the cancellation signal generator.

14. A power conversion system comprising:
a power conversion device which converts power outputted from an AC or DC power supply to AC or DC power; and
the noise filter according to claim 1.

15. The power conversion system according to claim 14, wherein
the power conversion device includes a prediction calculator which outputs a resonant frequency prediction value on the basis of the abnormality detection signal, and changes a switching frequency on the basis of the resonant frequency prediction value.

16. The power conversion system according to claim 14, wherein
the power conversion device includes an abnormality estimator which determines whether or not the abnormality detection signal has continued for not less than a predetermined period and outputs an abnormality continuation determination value in a case where the abnormality detection signal has continued for not less than the predetermined period, and stops operation of the power conversion device on the basis of the abnormality continuation determination value.

17. A management system comprising:
a power conversion device which converts power outputted from an AC or DC power supply to AC or DC power;
the noise filter according to claim 1, the noise filter further including a communicator which is connected to a cancellation signal output circuitry composing the noise filter and transmits data to outside; and
a management device having a database for storing the data transmitted from the communicator, and a data analyzer which analyzes the data.

18. A noise filter provided on one of an electric path connecting an AC or DC power supply and a power conversion device which converts power outputted from the AC or DC power supply to AC or DC power, or an electric path connecting the power conversion device and a load, the noise filter comprising:
a noise detector which detects common mode noise occurring during operation of the power conversion device;
a cancellation signal generator which generates a cancellation signal for canceling out the common mode noise;
a cancellation signal injection circuitry which injects the cancellation signal into the electric path; and
an abnormality detector which outputs an abnormality detection signal in a case where it is detected that the cancellation signal is abnormal, wherein
an abnormality processing sequence is executed on the basis of the abnormality detection signal, and
the abnormality processing sequence is a sequence in which, on the basis of the abnormality detection signal, the power conversion device performs determination for abnormality, and on the basis of a resonant frequency predicted in a prediction calculator that the power conversion device has, a switching frequency is changed.

19. A noise filter provided on one of an electric path connecting an AC or DC power supply and a power conversion device which converts power outputted from the AC or DC power supply to AC or DC power, or an electric path connecting the power conversion device and a load, the noise filter comprising:
a noise detector which detects common mode noise occurring during operation of the power conversion device;
a cancellation signal generator which generates a cancellation signal for canceling out the common mode noise;
a cancellation signal injection circuitry which injects the cancellation signal into the electric path; and
an abnormality detector which outputs an abnormality detection signal in a case where it is detected that the cancellation signal is abnormal, wherein
an abnormality processing sequence is executed on the basis of the abnormality detection signal, and
the abnormality processing sequence is a sequence in which, on the basis of the abnormality detection signal, the power conversion device performs determination for abnormality, and the power conversion device is stopped.
